(19) United States
(12) Patent Application Publication
(10) Pub. No.: US 2022/0416830 A1
(43) Pub. Date: Dec. 29, 2022

(54) IN-VEHICLE WIRELESS SYSTEM

(71) Applicants: AutoNetworks Technologies, Ltd., Mie (JP); Sumitomo Wiring Systems, Ltd., Mie (JP); SUMITOMO ELECTRIC INDUSTRIES, LTD., Osaka (JP)

(72) Inventors: Haruhiko TAKAOKA, Mie (JP); Yuta MIYAGAWA, Osaka (JP)

(73) Assignees: AutoNetworks Technologies, Ltd., Mie (JP); Sumitomo Wiring Systems, Ltd., Mie (JP); SUMITOMO ELECTRIC INDUSTRIES, LTD., Osaka (JP)

(21) Appl. No.: 17/771,208

(22) PCT Filed: Oct. 21, 2020
(86) PCT No.: PCT/JP2020/039531

§ 371 Date: Apr. 22, 2022

(30) Foreign Application Priority Data
Nov. 8, 2019 (JP) 2019-203184

(51) Int. Cl. H04B 1/3822; H04B 7/08; H04W 4/48

(52) U.S. Cl. CPC H04B 1/3822; H04B 7/08; H04W 4/48

(57) ABSTRACT

A first group includes first antennas and a first receiver. A second group includes second antennas and a second receiver. Each of the first antennas outputs a first signal according to a first communication form. Each of the second antennas outputs a second signal according to a second communication form. The first receiver receives the first signals individually outputted from the first antennas using a diversity form. The second receiver receives the second signals individually outputted from the second antennas using a diversity form. The multiplexer supplies the multiplex signal obtained by multiplexing the first signal and the second signal to the transmission line. The demultiplexer supplies the first signal and the second signal obtained by demultiplexing the multiplex signal to the first receiver and the second receiver, respectively.

### TECHNICAL FIELD

The present disclosure relates to an in-vehicle wireless system.

### BACKGROUND ART

A so-called in-vehicle wireless system is a wireless system mounted to a vehicle, and receives terrestrial digital broadcasting, for example. In a receiving system of receiving the terrestrial digital broadcasting, reception adopting a diversity form (also referred to as “diversity reception” hereinafter) is adopted in some cases for purpose of achieving stable reception.

In the diversity reception, a plurality of antennas are used for one communication media, and in the receiving system of receiving the terrestrial digital broadcasting, four antennas are used, for example.

In Patent Document 1 described hereinafter, four antennas are disposed in different positions in a vehicle, and a signal obtained from these antennas is transmitted by one transmission line. The signal obtained from the four antennas is once converted into frequencies different from each other, and then multiplexed, and the multiplexed signal (also referred to as “multiplex signal” hereinafter) are transmitted by one transmission line. The multiplex signal is demultiplexed, and four signals having original frequencies are obtained using cross-modulation by a non-linear amplifier. The four signals are supplied to a tuner.

Such a technique reduces the number of transmission lines routed between the four antennas and the tuner, thereby reducing a space necessary for routing (also referred to as “a routing space” hereinafter). Patent Document 1 exemplifies a case where a large routing space cannot be ensured in a pillar included in a vehicle body.

### PRIOR ART DOCUMENTS

### Patent Documents

Patent Document 1: Japanese Patent Application Laid-Open No. 2011-40833

### SUMMARY

### Problem to be Solved by the Invention

In the technique described in Patent Document 1, a frequency conversion circuit and a non-linear amplifier are adopted for performing multiplexing and demultiplexing, and a circuit dimension gets large. The in-vehicle wireless system also corresponds to the other communication media exemplified by radio broadcasting, a global positioning system (GPS), intelligent transport systems (ITS), a mobile phone, and an electronic toll collection system (ETC) in addition to the terrestrial digital broadcasting in many cases. A communication form adopted in the communication media such as a frequency, a modulation form, and a demodulation form, for example, generally differs for each communication media. Thus, multiplexing and demultiplexing on only the terrestrial digital broadcasting do not necessarily contribute to reduction in the number of transmission lines.

Accordingly, an object of the present disclosure is to reduce the number of transmission lines in an in-vehicle wireless system corresponding to a plurality of communication forms.

### Means to Solve the Problem

An in-vehicle wireless system according to the present disclosure includes a first group, a second group, a multiplexer, a demultiplexer, and a transmission line each mounted to a vehicle. The first group includes first antennas and a first receiver. The second group includes second antennas and a second receiver. Each of the first antennas outputs a first signal according to a first communication form. Each of the second antennas outputs a second signal according to a second communication form different from the first communication form. The first receiver receives the first signals individually outputted from the first antennas using a diversity form. The second receiver receives the second signals individually outputted from the second antennas using a diversity form. The multiplexer supplies a multiplex signal, which is a signal obtained by multiplexing at least the first signal obtained from an initial one of the first antennas and the second signal obtained from an initial one of the second antennas, to the transmission line. The demultiplexer supplies the first signal and the second signal obtained by demultiplexing the multiplex signal to the first receiver and the second receiver, respectively.

### Effects of the Invention

According to the present disclosure, the number of transmission lines is reduced in an in-vehicle wireless system corresponding to a plurality of communication forms.

### BRIEF DESCRIPTION OF DRAWINGS

FIG. 1 is a plan view schematically illustrating a vehicle body.

FIG. 2 is a wiring diagram schematically illustrating a configuration of an in-vehicle wireless system.

FIG. 3 is a block diagram illustrating an in-vehicle wireless system according to an embodiment 1.

FIG. 4 is a block diagram illustrating a modification of the in-vehicle wireless system according to the embodiment 1.

FIG. 5 is a block diagram illustrating an in-vehicle wireless system according to an embodiment 2.

FIG. 6 is a block diagram illustrating a first modification of the in-vehicle wireless system according to the embodiment 2.

FIG. 7 is a block diagram illustrating a second modification of the in-vehicle wireless system according to the embodiment 2.

FIG. 8 is a block diagram illustrating an in-vehicle wireless system according to an embodiment 3.

FIG. 9 is a block diagram illustrating a first modification of the in-vehicle wireless system according to the embodiment 3.

FIG. 10 is a block diagram illustrating a second modification of the in-vehicle wireless system according to the embodiment 3.

FIG. 11 is a block diagram illustrating an in-vehicle wireless system according to an embodiment 4.

FIG. 12 is a block diagram illustrating a further modification of the second modification of the in-vehicle wireless system according to the embodiment 2.

### DESCRIPTION OF EMBODIMENT(S)

### Description of Embodiment of Present Disclosure

Embodiments of the present disclosure are listed and described firstly.

(1) An in-vehicle wireless system according to the present disclosure includes a first group, a second group, a multiplexer, a demultiplexer, and a transmission line each mounted to a vehicle. The first group includes first antennas and a first receiver. The second group includes second antennas and a second receiver. Each of the first antennas outputs a first signal according to a first communication form. Each of the second antennas outputs a second signal according to a second communication form different from the first communication form. The first receiver receives the first signals individually outputted from the first antennas using a diversity form. The second receiver receives the second signals individually outputted from the second antennas using a diversity form. The multiplexer supplies a multiplex signal, which is a signal obtained by multiplexing the first signal obtained from an initial one of the first antennas and the second signal obtained from an initial one of the second antennas, to the transmission line. The demultiplexer supplies the first signal and the second signal obtained by demultiplexing the multiplex signal to the first receiver and the second receiver, respectively.

In the above configuration, the number of transmission lines is reduced by multiplexing and demultiplexing.

(2) A distance between the initial one of the first antennas and the initial one of the second antennas is preferably shorter than a distance between the initial one of the first antennas and a secondary one of the first antennas.

In the above configuration, the transmission line connecting the multiplexer to the initial one of the first antennas and the initial one of the second antennas is short.

(3) The first antennas, a total number of which is P, are provided in the first group, the second antennas, a total number of which is Q, are provided in the second group, multiplexers, a total number of which is R, are provided, and demultiplexers, a total number of which is R, are provided. It is preferable that in any case where each of P and Q is an integer equal to or larger than 2, R is an integer equal to one of P and Q, which is smaller than another one of P and Q, and S is an integer equal to or smaller than R and equal to or larger than 1, (a) an Sth one of the multiplexers multiplexes at least the first signal obtained from an Sth one of the first antennas and the second signal obtained from an Sth one of the second antennas to obtain an Sth one of the multiplex signals; and (b) an Sth one of the demultiplexers supplies the first signal and the second signal, both of which are obtained by demultiplexing the Sth one of the multiplex signals, to the first receiver and the second receiver, respectively.

In the above configuration, all of the first signals or all of the second signals are subject to multiplexing, thus an effect of reducing the transmission line is highly achieved.

(4) It is preferable that both a distance between an initial one of the multiplexers and the initial one of the first antennas and a distance between an initial one of the muliplexers and the initial one of the second antennas are shorter than a distance between the initial one of the multiplexers and a secondary one of the first antennas and a distance between the initial one of the multiplexers and a secondary one of the second antennas, and both a distance between a secondary one of the multiplexers and the secondary one of the first antennas and a distance between the secondary one of the multiplexers and the secondary one of the second antennas are shorter than a distance between the secondary one of the multiplexers and the initial one of the first antennas and a distance between the secondary one of the multiplexers and the initial one of the second antennas.

In the above configuration, a length of the transmission line connecting the multiplexer and the antennas outputting the antenna signals to be multiplexed by the multiplexer is reduced.

(5) It is preferable that an integer Q is larger than an integer P, an Lth one of the second antennas is located closer to the second receiver in relation to all of the multiplexers, and L is equal to or smaller than Q, and any integer equal to or larger than (P+1) is applied to the L.

In the above configuration, a length of the transmission line connecting the multiplexer and the antennas outputting the antenna signals to be multiplexed by the multiplexer is reduced.

(6) It is preferable that an in-vehicle wireless system according to the present disclosure further includes a third group mounted to a vehicle, wherein the third group includes third antennas and wireless devices corresponding to each of the third antennas, all of the third antennas output third signals according to third communication systems, which are different from the first communication system and the second communication system and are different from each other, the wireless devices receive the third signals individually outputted from the third antennas corresponding to the wireless devices, an initial one of the third signals is not multiplexed with a secondary one of the third signals but is multiplexed with any of the second signals to obtain a second multiplex signal, the initial one of the third signals obtained by demultiplexing the second multiplex signal is supplied to an initial one of the wireless devices corresponding to the initial one of the third signals, and a frequency range adopted to the secondary one of the third signals ranges between a frequency range adopted to the second signals and a frequency range adopted to the initial one of the third signals.

In the above configuration, a degree of technical difficulty of constituting the multiplexer and the demultiplexer is low.

(7) It is also applicable that an initial one of the wireless devices has a function of outputting a fourth signal according to an initial one of the third communication forms, and a secondary one of the wireless devices has a function of outputting a fifth signal according to a secondary one of the third communication forms. In this case, it is preferable that the in-vehicle wireless system according to the present disclosure further includes a transmission multiplexer multiplexing the fourth signal and the fifth signal to obtain a sixth signal and an output demultiplexer supplying the fourth signal obtained by demultiplexing the sixth signal to the third antennas corresponding to the initial one of the wireless devices and supplying the fifth signal obtained by demultiplexing the sixth signal to the third antennas corresponding to the secondary one of the wireless devices.

In the above configuration, the number of transmission lines is reduced also for the transmission.

A correspondence between the expression described above and embodiments described hereinafter is mentioned in “generalized description” described after an embodiment 4.

### Details of Embodiment of Present Disclosure

Specific examples of an in-vehicle wireless system according to the present disclosure are described hereinafter with reference to the drawings. The present disclosure is not limited to these examples, but is indicated by claims, and it is intended that meanings equivalent to claims and all modifications within a scope of claims are included.

### Description Adopted to Various Embodiments in Common

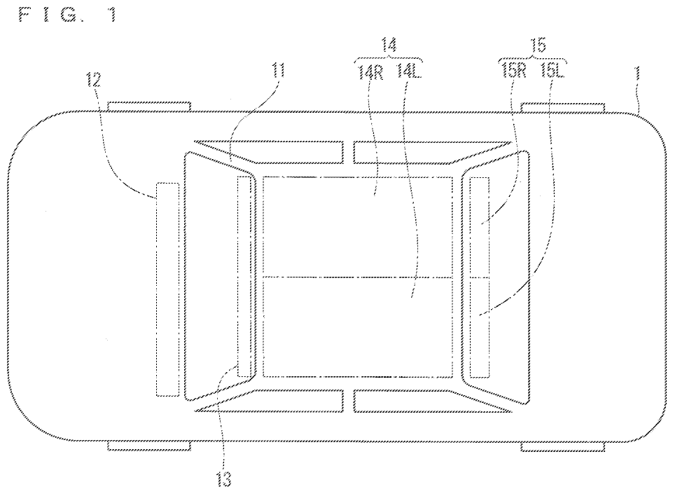

FIG. 1 is a plan view schematically illustrating a vehicle body 1. Any in-vehicle wireless system according to the embodiments and modifications thereof described hereinafter may also be mounted to the vehicle body 1.

Regions 13, 14, and 15 are regions where antennas are disposed in a front glass, a roof, and a rear glass of the vehicle body 1, respectively. The region 14 includes a region 14L on a left side with respect to a traveling direction (a direction from the region 15 to the region 13) of the vehicle body 1 and a region 14R on a right side with respect to the traveling direction of the vehicle body 1. The region 15 includes a region 15L on a left side with respect to the traveling direction of the vehicle body 1 and a region 15R on a right side with respect to the traveling direction of the vehicle body 1. A region 12 is a region where a receiver is disposed in a back of an instrument panel. A region 11 is a region where a transmission line is routed in a so-called A pillar.

A demultiplexer is also disposed in the region 12. A multiplexer is also disposed in the region 14. Amplifiers corresponding to antennas disposed in the regions 14 and 15, respectively, are disposed in the regions 14 and 15 in some cases. Transmission lines may also be routed in the regions 12, 13, 14, and 15.

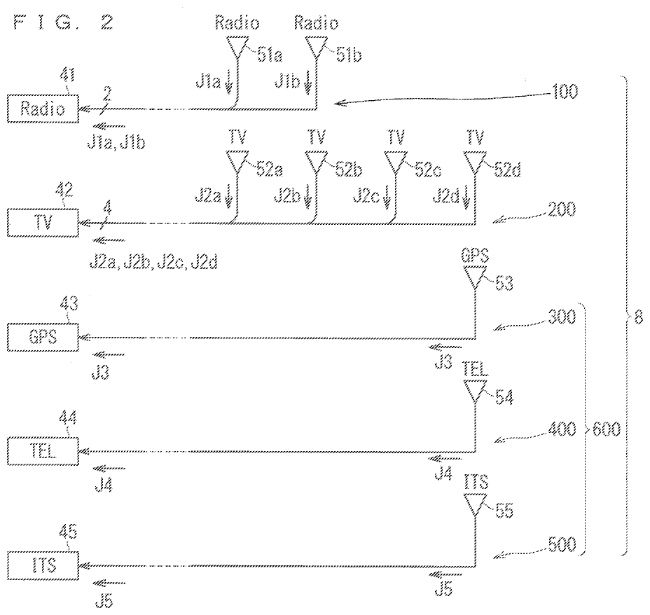

FIG. 2 is a wiring diagram schematically illustrating a configuration of an in-vehicle wireless system 8. The in-vehicle wireless system 8 includes groups 100, 200, 300, 400, and 500.

The group 100 has a configuration of receiving radio broadcasting, and includes a receiver 41 and antennas 51a and 51b (all of them are additionally illustrated as “Radio” in the drawings: the same applies to the following description). The receiver 41 receives antenna signals J1a and J1b individually outputted from the antennas 51a and 51b using a diversity form. A slash and a number “2” additionally illustrated in an arrow inputted to the receiver 41 mean that two antenna signals J1a and J1b are inputted to the receiver 41.

Herein, “the antenna signals” are not signals outputted from an antenna as radio waves but are signals obtained from an antenna by receiving radio waves through the antenna (also referred to as “radio receiving” hereinafter).

The group 200 has a configuration of receiving terrestrial digital broadcasting, and includes a receiver 42 and antennas 52a, 52b, 52c, and 52d (all of them are additionally illustrated as “TV” in the drawings: the same applies to the following description). The receiver 42 receives antenna signal individually outputted from the antennas 52a. 52b, 52c, and 52d using a diversity form. A slash and a number “4” additionally illustrated in an arrow inputted to the receiver 42 mean that four types of antenna signals J2a, J2b, J2c, and J2d are inputted to the receiver 42.

The group 300 has a configuration of receiving signals adopted to GPS (also referred to as “a GPS signal” hereinafter), and includes a receiver 43 and an antenna 53 (all of them are additionally illustrated as “GPS” in the drawings: the same applies to the following description). The receiver 43 receives an antenna signal J3 outputted from the antenna 53. The antenna signal J3 functions as the GPS signal.

The group 400 has a configuration of receiving a signal adopted to a mobile phone (also referred to as “a TEL signal” hereinafter), and includes a receiver 44 and an antenna 54 (all of them are additionally illustrated as “TEL” in the drawings: the same applies to the following description). The receiver 44 receives an antenna signal J4 outputted from the antenna 54. The antenna signal J4 functions as the TEL signal.

The group 500 has a configuration of receiving a signal adopted to ITS (also referred to as “an ITS signal” hereinafter), and includes a receiver 45 and an antenna 55 (all of them are additionally illustrated as “ITS” in the drawings: the same applies to the following description). The receiver 45 receives an antenna signal J5 outputted from the antenna 55. The antenna signal J5 functions as the ITS signal.

The antennas 52a and 52b are disposed in the region 13. The antennas 53, 54, and 55 are disposed in the region 14L. The antennas 51a and 52c are disposed in the region 15R. The antennas 51b and 52d are disposed in the region 15L.

Table 1 is a table associating a communication media with a frequency adopted to the communication media. The radio broadcasting, the terrestrial digital broadcasting, and the mobile phone are shown as “Radio”, “TV”, and “TEL”, respectively to a column indicating the communication media in Table 1. Two frequency ranges can be selectively adopted to the mobile phone, thus these frequency ranges are shown as a range A and range B.

TABLE 1

| Communication media | Frequency | |
|---|---|---|
| Radio | Equal to or lower than 120 MHz | |
| TV | 470-710 | MHz |
| ITS | 755-765 | MHz |
| TEL (range A) | 815-960 | MHz |
| TEL (range B) | 1710-1990 | MHz |
| GPS | 1575 | MHz |

In all of the groups 100, 200, 300, 400, and 500, broken lines in FIG. 2 illustrate that a multiplexer and a demultiplexer intervene between a receiver and an antenna in some cases in a portion illustrated using the broken lines. There is also a case where the multiplexer and the demultiplexer do not intervene in the portion illustrated using the broken lines.

Embodiments described hereinafter individually describe whether or not the multiplexer and the demultiplexer intervene between the receiver and the antenna and how they intervene when they intervene.

Table 2 is a table showing a connection relationship between multiplexers 31 to 39, 301, and 302 and antennas 51a, 51b, 52a, 52b, 52c, 52d, 53, 54, and 55 described in the embodiments described hereinafter. An antenna outputting an antenna signal is described as an output source, and a multiplexer to which the antenna signal is inputted is described as an output destination.

TABLE 2

| Output destination | Output source |
|---|---|
| Multiplexer 31 | Antenna 51a, 52c, 53 |
| Multiplexer 32 | Antenna 51b, 52d |
| Multiplexer 33 | Antenna 52b, 54 |
| Multiplexer 34 | Antenna 52a, 55 |
| Multiplexer 35 | Antenna 51a, 52c, 53, 55 |
| Multiplexer 36 | Antenna 51b, 52d, 54 |
| Multiplexer 37 | Antenna 51a, 52c, 53, 54 |
| Multiplexer 38 | Antenna 51b, 52d, 55 |
| Multiplexer 39 | Antenna 51b, 52d, 54, 55 |
| Multiplexer 301 | Antenna 51a, 53, 55 |
| Multiplexer 302 | Antenna 51a, 53, 54 |

Table 3 is a table showing a connection relationship between demultiplexers 21 to 29, 201, and 202 and receivers 41 to 45 described in the embodiments described hereinafter. A demultiplexer outputting an antenna signal is described as an output source, and a receiver to which the antenna signal is inputted is described as an output destination.

TABLE 3

| Output destination | Output source |
|---|---|
| Receiver 41, 42, 43 | Demultiplexer 21 |
| Receiver 41, 42 | Demultiplexer 22 |
| Receiver 42, 44 | Demultiplexer 23 |
| Receiver 42, 45 | Demultiplexer 24 |
| Receiver 41, 42, 43, 45 | Demultiplexer 25 |
| Receiver 41, 42, 44 | Demultiplexer 26 |
| Receiver 41, 42, 43, 44 | Demultiplexer 27 |
| Receiver 41, 42, 45 | Demultiplexer 28 |
| Receiver 41, 42, 44, 45 | Demultiplexer 29 |
| Receiver 41, 43, 45 | Demultiplexer 201 |
| Receiver 41, 43, 44 | Demultiplexer 202 |

Each of the demultiplexers 21 to 29, 201, and 202 is connected to at least one of the multiplexers 31 to 39, 301, and 302 via transmission lines 61 to 69, 601, and 602 described in the embodiments hereinafter.

Also in any embodiment described hereinafter, a frequency conversion circuit and a non-linear amplifier described in Patent Document 1 are not necessary in performing multiplexing and demultiplexing. Such non-necessity has an advantage in a viewpoint of avoiding increase in a circuit dimension.

### Embodiment 1

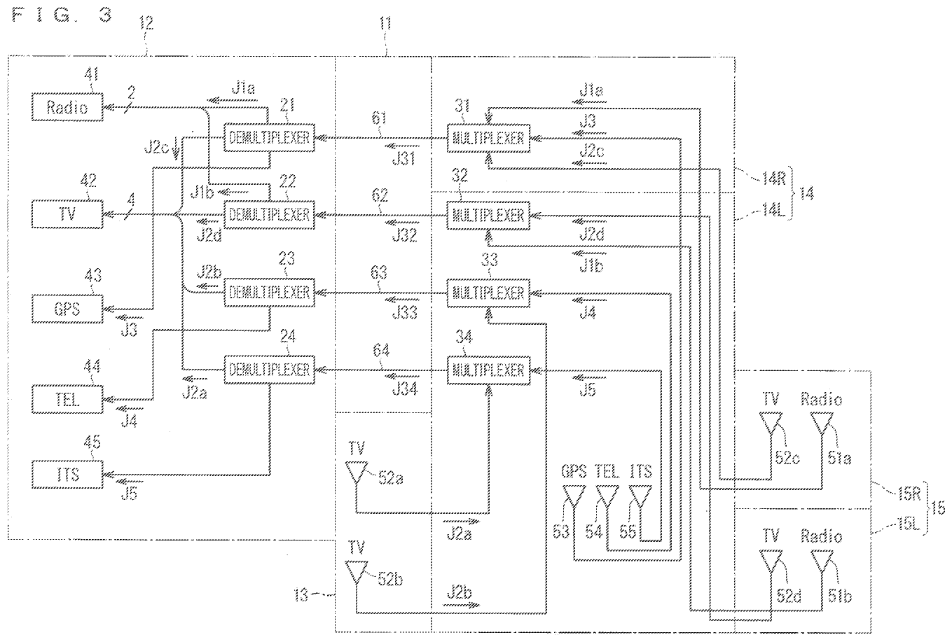

FIG. 3 is a block diagram illustrating an in-vehicle wireless system according to an embodiment 1. A sign “8” indicating the in-vehicle wireless system and signs “100”, “200”, “300”, “400”, and “500” indicating groups illustrated in FIG. 2 are omitted to avoid complexity in illustration (the same applies to the following description).

The multiplexer 31 is disposed in the region 14R. The multiplexers 32, 33, and 34 are disposed in the region 14L. The demultiplexers 21, 22, 23, and 24 are disposed in the region 12.

The antenna signals J1a, J2c, and J3 are inputted to the multiplexer 31, and the multiplexer 31 multiplexes the antenna signals J1a, J2c, and J3 to obtain a multiplex signal J31, and outputs the multiplex signal J31.

The antenna signals J1b and J2d are inputted to the multiplexer 32, and the multiplexer 32 multiplexes the antenna signals J1b and J2d to obtain a multiplex signal J32, and outputs the multiplex signal J32.

The antenna signals J2b and J4 are inputted to the multiplexer 33, and the multiplexer 33 multiplexes the antenna signals J2b and J4 to obtain a multiplex signal J33, and outputs the multiplex signal J33.

The antenna signals J2a and J5 are inputted to the multiplexer 34. The multiplexer 34 multiplexes the antenna signals J2a and J5 to obtain a multiplex signal J34, and outputs the multiplex signal J34.

The multiplex signal J31 is supplied from the multiplexer 31 to the transmission line 61. The multiplex signal J32 is supplied from the multiplexer 32 to the transmission line 62. The multiplex signal J33 is supplied from the multiplexer 33 to the transmission line 63. The multiplex signal J34 is supplied from the multiplexer 34 to the transmission line 64.

The multiplex signal J31 is inputted to the demultiplexer 21. The demultiplexer 21 demultiplexes the multiplex signal J31 to obtain the antenna signal J1a, and outputs the antenna signal J1a to the receiver 41. The demultiplexer 21 demultiplexes the multiplex signal J31 to obtain the antenna signal J2c, and outputs the antenna signal J2c to the receiver 42. The demultiplexer 21 demultiplexes the multiplex signal J31 to obtain the antenna signal J3, and outputs the antenna signal J3 to the receiver 43.

The multiplex signal J32 is inputted to the demultiplexer 22. The demultiplexer 22 demultiplexes the multiplex signal J32 to obtain the antenna signal J1b, and outputs the antenna signal J1b to the receiver 41. The demultiplexer 22 demultiplexes the multiplex signal J32 to obtain the antenna signal J2d, and outputs the antenna signal J2d to the receiver 42.

The multiplex signal J33 is inputted to the demultiplexer 23. The demultiplexer 23 demultiplexes the multiplex signal J33 to obtain the antenna signal J2b, and outputs the antenna signal J2b to the receiver 42. The demultiplexer 23 demultiplexes the multiplex signal J33 to obtain the antenna signal J4, and outputs the antenna signal J4 to the receiver 44.

The multiplex signal J34 is inputted to the demultiplexer 24. The demultiplexer 24 demultiplexes the multiplex signal J34 to obtain the antenna signal J2a, and outputs the antenna signal J2a to the receiver 42. The demultiplexer 24 demultiplexes the multiplex signal J34 to obtain the antenna signal J, and outputs the antenna signal J5 to the receiver 45.

The receiver 41 receives the antenna signal J1a obtained from the demultiplexer 21 and the antenna signal J1b obtained from the demultiplexer 22 using a diversity form.

The receiver 42 receives the antenna signal J2c obtained from the demultiplexer 21, the antenna signal J2d obtained from the demultiplexer 22, the antenna signal J2b obtained from the demultiplexer 23, and the antenna signal J2a obtained from the demultiplexer 24 using a diversity form.

The receiver 43 receives the antenna signal J3 obtained from the demultiplexer 21. The receiver 44 receives the antenna signal J4 obtained from the demultiplexer 23. The receiver 45 receives the antenna signal J5 obtained from the demultiplexer 24.

Transmission lines 61, 62, 63, and 64 are routed in the region 11. In a case where multiplexing on the antenna signals J1a, J1b, J2a, J2b, J2c, J2d, J3, J4, and J5 and demultiplexing on the multiplex signals J31, J32, J33, and J34 are not performed, nine transmission lines are necessary to be routed in the region 11 with reference to FIG. 2. In contrast, four transmission lines are needed to be routed in the region 11 in the present embodiment, and the number of transmission lines routed in the region 11 is reduced by multiplexing and demultiplexing.

### Modification of Embodiment 1

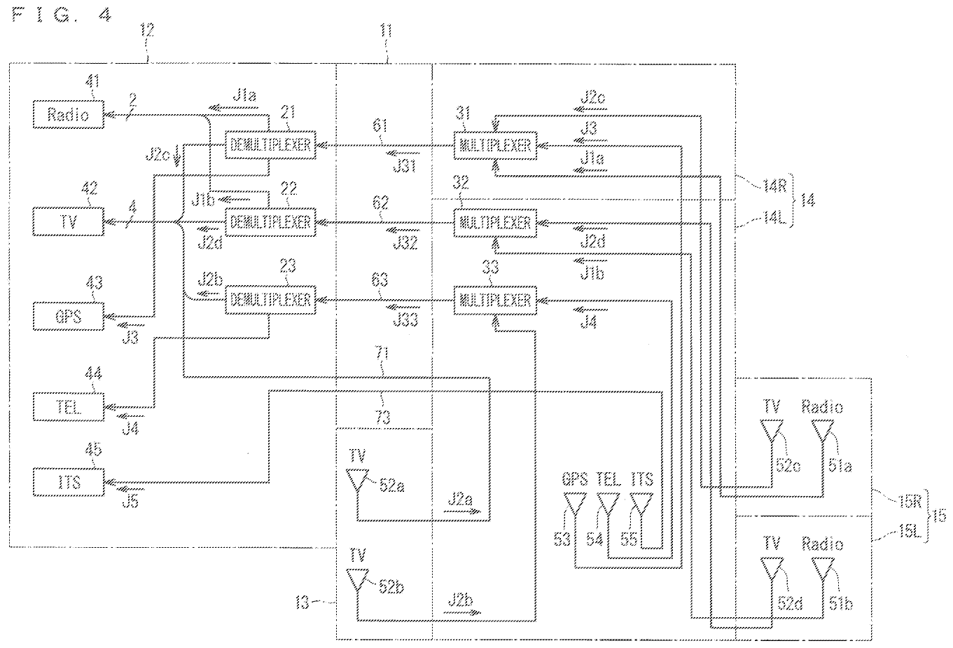

FIG. 4 is a block diagram illustrating a modification of the in-vehicle wireless system according to the embodiment 1. In this modification, adopted to the configuration illustrated in FIG. 3 (referred to as “the first configuration” hereinafter) is a configuration that the antenna signals J2a and J5 are not multiplexed and the multiplex signal J34 is not demultiplexed. More specifically, adopted in this modification is a configuration that the multiplexer 34, the transmission line 64, and the demultiplexer 24 in the first configuration are replaced with transmission lines 71 and 73 (referred to as “the second configuration” hereinafter).

The multiplexer 31 is disposed in the region 14R. The multiplexers 32 and 33 are disposed in the region 14L. The demultiplexers 21, 22, and 23 are disposed in the region 12.

The transmission line 71 transmits the antenna signal J2a from the antenna 52a to the receiver 42. The transmission line 73 transmits the antenna signal J5 from the antenna 55 to the receiver 45. Multiplexing on the antenna signals J1a, J1b, J2b, J2c, J2d, J3, and J4 and demultiplexing on the multiplex signals J31, J32, and J33 are the same as those performed in the first configuration.

As shown in Table 1, a frequency in 755 to 765 MHz is adopted in ITS, and a frequency in 470 to 710 MHz is adopted in terrestrial digital broadcasting. When the frequencies adopted in each of the plurality of antenna signals are close to each other, a high level of technique is needed to multiplex these antenna signals and demultiplex the multiplex signals obtained by multiplexing into the antenna signals. With respect to the first configuration, a difference between a lower limit of the frequency 755 MHz adopted in the ITS and an upper limit of the frequency 710 MHz adopted in the terrestrial digital broadcasting is less than 50 MHz. Thus, a high level of technique is needed for both the multiplexer 34 and the demultiplexer 24.

This modification (the second configuration) has an advantage in a viewpoint that adoption of a high level of technique can be avoided compared with the first configuration. The second configuration also has an advantage in a viewpoint that the number of necessary multiplexers and demultiplexers is small compared with the first configuration.

Five transmission lines 61, 62, 63, 71, and 73 are routed in the region 11 in the second configuration, thus an effect of reducing the number of transmission lines routed in the region 11 is small compared with the first configuration.

### Embodiment 2

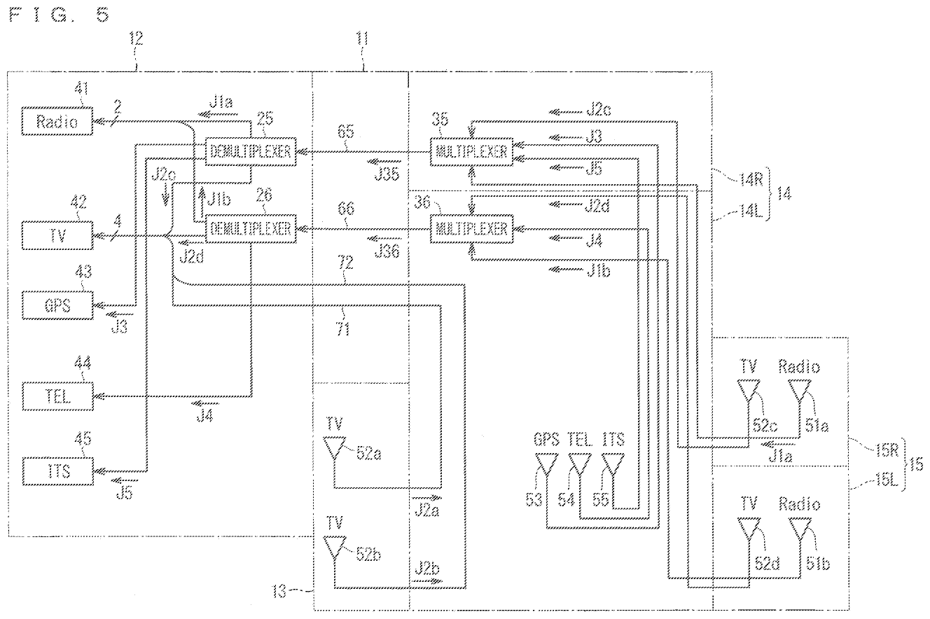

FIG. 5 is a block diagram illustrating an in-vehicle wireless system according to an embodiment 2.

The multiplexer 35 is disposed in the region 14R. The multiplexer 36 is disposed in the region 14L. The demultiplexers 25 and 26 are disposed in the region 12.

The antenna signals J1a, J2c, J3, and J5 are inputted to the multiplexer 35, and the multiplexer 36 multiplexes the antenna signals J1a, J2c, J3, and J5 to obtain a multiplex signal J35, and outputs the multiplex signal J35.

The antenna signals J1b, J2d, and J4 are inputted to the multiplexer 36, and the multiplexer 36 multiplexes the antenna signals J1b, J2d, and J4 to obtain a multiplex signal J36, and outputs the multiplex signal J36.

The multiplex signal J35 is supplied from the multiplexer 35 to the transmission line 65. The multiplex signal J36 is supplied from the multiplexer 36 to the transmission line 66.

The multiplex signal J35 is inputted to the demultiplexer 25. The demultiplexer 25 demultiplexes the multiplex signal J35 to obtain the antenna signal J1a, and outputs the antenna signal J1a to the receiver 41. The demultiplexer 25 demultiplexes the multiplex signal J35 to obtain the antenna signal J2c, and outputs the antenna signal J2c to the receiver 42. The demultiplexer 25 demultiplexes the multiplex signal J35 to obtain the antenna signal J3, and outputs the antenna signal J3 to the receiver 43. The demultiplexer 25 demultiplexes the multiplex signal J35 to obtain the antenna signal J5, and outputs the antenna signal J5 to the receiver 45.

The multiplex signal J36 is inputted to the demultiplexer 26. The demultiplexer 26 demultiplexes the multiplex signal J36 to obtain the antenna signal J1b, and outputs the antenna signal J1b to the receiver 41. The demultiplexer 26 demultiplexes the multiplex signal J36 to obtain the antenna signal J2d, and outputs the antenna signal J2d to the receiver 42. The demultiplexer 26 demultiplexes the multiplex signal J36 to obtain the antenna signal 4, and outputs the antenna signal J4 to the receiver 44.

The transmission line 71 transmits the antenna signal J2a from the antenna 52a to the receiver 42. The transmission line 72 transmits the antenna signal J2b from the antenna 52b to the receiver 42. Transmission lines 65, 66, 71, and 72 are routed in the region 11.

The receiver 41 receives the antenna signal J1a obtained from the demultiplexer 25 and the antenna signal J1b obtained from the demultiplexer 26 using a diversity form.

The receiver 42 receives the antenna signal J2c obtained from the demultiplexer 25, the antenna signal J2d obtained from the demultiplexer 26, the antenna signal J2b obtained from the transmission line 72, and the antenna signal J2a obtained from the transmission line 71 using a diversity form.

The receiver 43 receives the antenna signal J3 obtained from the demultiplexer 25. The receiver 44 receives the antenna signal J4 obtained from the demultiplexer 26. The receiver 45 receives the antenna signal J5 obtained from the demultiplexer 25.

A configuration according to the present embodiment illustrated in FIG. 5 (referred to as “the third configuration” hereinafter) has an effect in common with the first configuration in that four transmission lines are routed in the region 11. The third configuration has an advantage in a viewpoint that the number of transmission lines is small compared with the second configuration.

The third configuration has an advantage in a viewpoint that the number of multiplexers and demultiplexers is small compared with any of the first configuration and the second configuration.

Reduction in the number of routed transmission lines or reduction in length of the routed transmission lines or both of them are desired in the region 14. The multiplexer is preferably located close to the antenna outputting the antenna signal to be multiplexed.

In the third configuration, multiplexing on the antenna signal J2a and J2b is not performed. Transmission lines 71 and 72 are not needed to be routed in a position in the region 14 close to the region 15. The length of the transmission lines 71 and 72 is reduced. The multiplexers 35 and 36 can be disposed in the region 14 close to the region 15. Adoption of the transmission lines 71 and 72 contributes to at least one of the reduction in the number of routed transmission lines routed in the region 14 and the reduction in length thereof described above.

In the third configuration, any of the frequency in the range A and the frequency in the range B may be adopted to the mobile phone. The reason is that a frequency 100 MHz or more away from the frequency in the ranges A and B is adopted to both the antenna signals J1b and J2d multiplexed with the antenna signal J4 corresponding to the mobile phone in the multiplexer 36.

Generally, a degree of technical difficulty in constituting the multiplexer is lower in a case where the frequency ranges of the signal to be multiplexed by the multiplexer are away from each other than a case where they are close to each other. The same applies to the demultiplexer. Thus, the frequency ranges of the signal to be multiplexed and demultiplexed are preferably away from each other.

In the third configuration, both the frequency in the range A and the frequency in the range B may be adopted to the mobile phone. The multiplexer 36 in this case is assumed to multiplex the antenna signal J4 using a function of a high-pass filter.

### First Modification of Embodiment 2

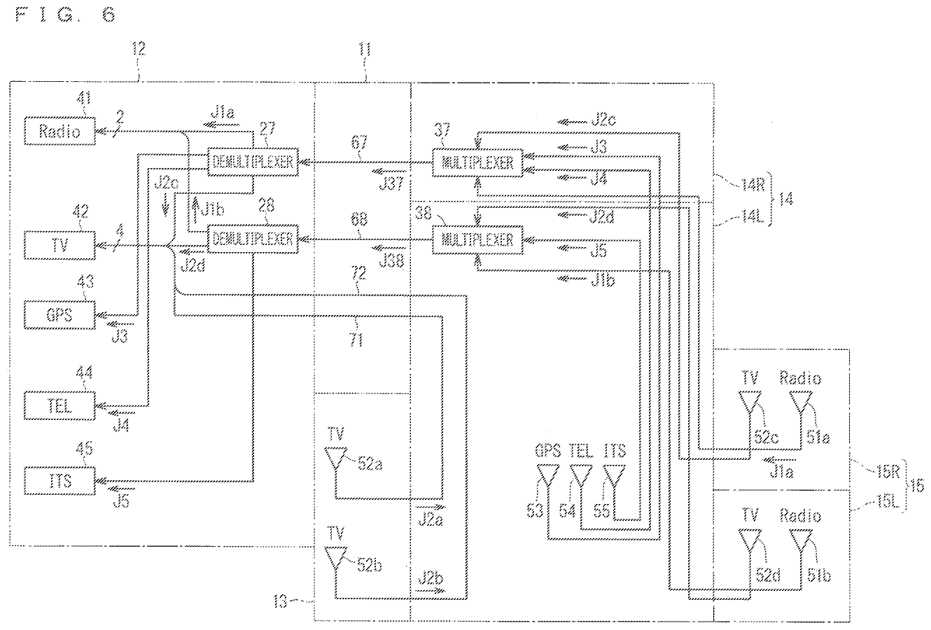

FIG. 6 is a block diagram illustrating a first modification of the in-vehicle wireless system according to the embodiment 2. Adopted in this modification is a configuration that the antenna signal multiplexed with the antenna signal J4 and the antenna signal multiplexed with the antenna signal J5 are replaced in the third configuration.

In a configuration illustrated in FIG. 6 (referred to as “the fourth configuration” hereinafter), the antenna signal J5 multiplexed with the antenna signals J1a, J2c, and J3 in the third configuration are replaced with the antenna signal J4, and the antenna signal J4 multiplexed with the antenna signals J1b and J2d in the third configuration are replaced with the antenna signal J5. More specifically, adopted in this modification is a configuration that the multiplexers 35 and 36, the transmission lines 65 and 66, and the demultiplexers 25 and 26 in the third configuration are replaced with the multiplexers 37 and 38, transmission lines 67 and 68, and demultiplexers 27 and 28.

The multiplexer 37 is disposed in the region 14R. The multiplexer 38 is disposed in the region 14L. The demultiplexers 27 and 28 are disposed in the region 12.

The antenna signals J1a, J2c, J3, and J4 are inputted to the multiplexer 37, and the multiplexer 37 multiplexes the antenna signals J1a, J2c, J3, and J4 to obtain multiplex signal J37, and outputs the multiplex signal J37.

The antenna signals J1b, J2d, and J5 are inputted to the multiplexer 38, and the multiplexer 38 multiplexes the antenna signals J1b, J2d, and J5 to obtain multiplex signal J38, and outputs the multiplex signal J38.

The multiplex signal J37 is supplied from the multiplexer 37 to the transmission line 67. The multiplex signal J38 is supplied from the multiplexer 38 to the transmission line 68.

The multiplex signal J37 is inputted to the demultiplexer 27. The demultiplexer 27 demultiplexes the multiplex signal J37 to obtain the antenna signal J1a, and outputs the antenna signal J1a to the receiver 41. The demultiplexer 27 demultiplexes the multiplex signal J37 to obtain the antenna signal J2c, and outputs the antenna signal J2c to the receiver 42. The demultiplexer 27 demultiplexes the multiplex signal J37 to obtain the antenna signal J3, and outputs the antenna signal J3 to the receiver 43. The demultiplexer 27 demultiplexes the multiplex signal J37 to obtain the antenna signal J4, and outputs the antenna signal J4 to the receiver 44.

The multiplex signal J38 are inputted to the demultiplexer 28. The demultiplexer 28 demultiplexes the multiplex signal J38 to obtain the antenna signal J1b, and outputs the antenna signal J1b to the receiver 41. The demultiplexer 28 demultiplexes the multiplex signal J38 to obtain the antenna signal J2d, and outputs the antenna signal J2d to the receiver 42. The demultiplexer 28 demultiplexes the multiplex signal J38 to obtain the antenna signal J5, and outputs the antenna signal J5 to the receiver 45.

The transmission line 71 transmits the antenna signal J2a from the antenna 52a to the receiver 42. The transmission line 72 transmits the antenna signal J2b from the antenna 52b to the receiver 42. Transmission lines 67, 68, 71, and 72 are routed in the region 11.

The receiver 41 receives the antenna signal J1a obtained from the demultiplexer 27 and the antenna signal J1b obtained from the demultiplexer 28 using a diversity form.

The receiver 42 receives the antenna signal J2c obtained from the demultiplexer 27, the antenna signal J2d obtained from the demultiplexer 28, the antenna signal J2b obtained from the transmission line 72, and the antenna signal J2a obtained from the transmission line 71 using a diversity form.

The receiver 43 receives the antenna signal J3 obtained from the demultiplexer 27. The receiver 44 receives the antenna signal J4 obtained from the demultiplexer 27. The receiver 45 receives the antenna signal J5 obtained from the demultiplexer 28.

The fourth configuration has an effect in common with the first configuration in that the number of transmission lines is reduced in the region 11. The fourth configuration has an advantage in a viewpoint that the number of transmission lines is small compared with the second configuration.

The fourth configuration has an effect in common with the third configuration in that the number of multiplexers and demultiplexers is reduced.

The fourth configuration contributes to at least one of the reduction in the number of transmission lines routed in the region 14 and the reduction in length thereof described above.

In the fourth configuration, the frequency in the range A is preferably adopted to the mobile phone. The reason is that a frequency adopted to the antenna signal J3 (the antenna signal J3 is adopted to GPS) multiplexed with the antenna signal J4 corresponding to the mobile phone in the multiplexer 37 is farther away from the range A in relation to the range B.

### Second Modification of Embodiment 2

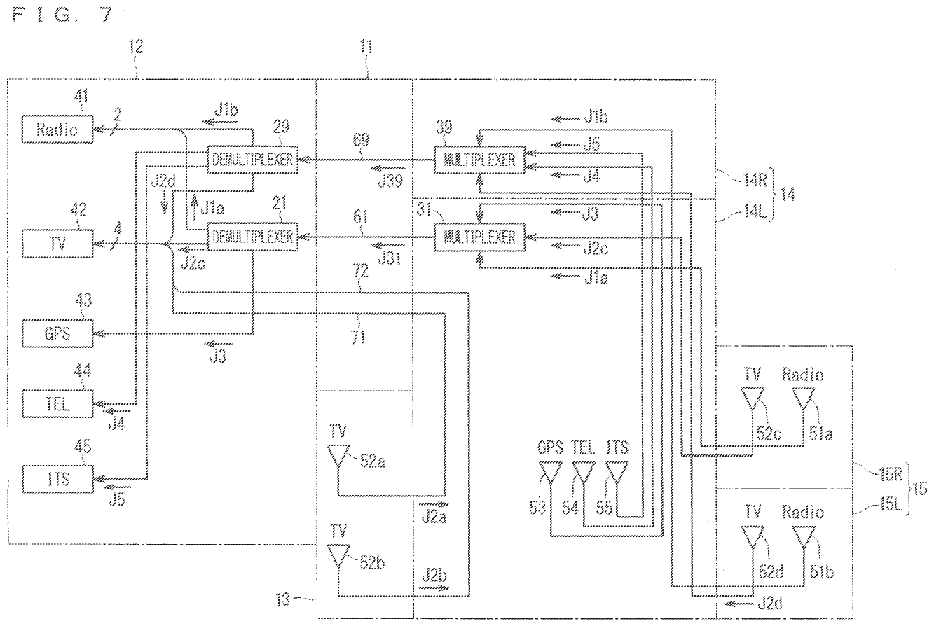

FIG. 7 is a block diagram illustrating a second modification of the in-vehicle wireless system according to the embodiment 2. Adopted in this modification is a configuration that the antenna signal J5 is not multiplexed with the antenna signals J1a, J2c, and J3 but are multiplexed with the antenna signals J1b, J2d, and J4. More specifically, adopted in this modification is a configuration that the multiplexers 35 and 36, the transmission lines 65 and 66, and the demultiplexers 25 and 26 in the third configuration are replaced with the multiplexers 31 and 39, transmission lines 61 and 69, and demultiplexers 29 and 21 (referred to as “the fifth configuration” hereinafter).

The multiplexer 31 is disposed in the region 14L. The multiplexer 39 is disposed in the region 14R. The demultiplexers 21 and 29 are disposed in the region 12.

The antenna signals J1a, J2c, and J3 inputted and outputted between the multiplexer 31, the transmission line 61, and the demultiplexer 21 are already described in the first configuration.

The antenna signals J1b, J2d, J4, and J5 are inputted to the multiplexer 39, and the multiplexer 39 multiplexes the antenna signals J1b, J2d, J4, and J5 to obtain a multiplex signal J39, and outputs the multiplex signal J39. The multiplex signal J39 is supplied from the multiplexer 39 to the transmission line 69.

The multiplex signal J39 is inputted to the demultiplexer 29. The demultiplexer 29 demultiplexes the multiplex signal J39 to obtain the antenna signal J1b, and outputs the antenna signal J1b to the receiver 41. The demultiplexer 29 demultiplexes the multiplex signal J39 to obtain the antenna signal J2d, and outputs the antenna signal J2d to the receiver 42. The demultiplexer 29 demultiplexes the multiplex signal J39 to obtain the antenna signal 34, and outputs the antenna signal J4 to the receiver 44. The demultiplexer 29 demultiplexes the multiplex signal J39 to obtain the antenna signal J5, and outputs the antenna signal J5 to the receiver 45.

The transmission line 71 transmits the antenna signal J2a from the antenna 52a to the receiver 42. The transmission line 72 transmits the antenna signal J2b from the antenna 52b to the receiver 42. Transmission lines 61, 69, 71, and 72 are routed in the region 11.

The receiver 41 receives the antenna signal J1a obtained from the demultiplexer 21 and the antenna signal 31b obtained from the demultiplexer 29 using a diversity form.

The receiver 42 receives the antenna signal J2c obtained from the demultiplexer 21, the antenna signal J2d obtained from the demultiplexer 29, the antenna signal J2b obtained from the transmission line 72, and the antenna signal J2a obtained from the transmission line 71 using a diversity form.

The receiver 43 receives the antenna signal J3 obtained from the demultiplexer 21. The receiver 44 receives the antenna signal J4 obtained from the demultiplexer 29. The receiver 45 receives the antenna signal J5 obtained from the demultiplexer 29.

The fifth configuration has an effect in common with the first configuration in that the number of transmission lines is reduced in the region 11. The fifth configuration has an advantage in a viewpoint that the number of transmission lines is small compared with the second configuration.

The fifth configuration has an effect in common with the third configuration in that the number of multiplexers and demultiplexers is reduced.

The fifth configuration contributes to at least one of the reduction in the number of transmission lines routed in the region 14 and the reduction in length thereof described above.

In the fifth configuration, the frequency in the range B is preferably adopted to the mobile phone. The reason is that a frequency adopted to the antenna signal J5 (the antenna signal J5 is adopted to ITS) multiplexed with the antenna signal J4 corresponding to the mobile phone in the multiplexer 39 is farther away from the range B in relation to the range A.

### Embodiment 3

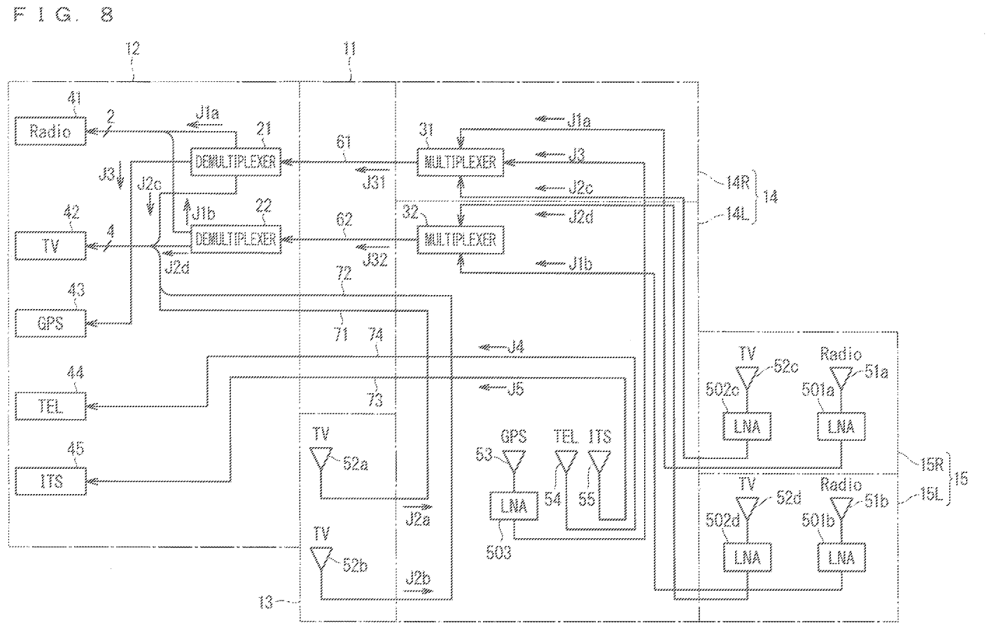

FIG. 8 is a block diagram illustrating an in-vehicle wireless system according to an embodiment 3. In the embodiment 3, adopted to the first configuration is a configuration that the antenna signals J2a, J5, J4, and J2b are not multiplexed and the multiplex signals J33 and J34 are not demultiplexed. More specifically, adopted in this modification is a configuration that the multiplexers 33 and 34, the transmission lines 63 and 64, and the demultiplexers 23 and 24 in the first configuration are replaced with transmission lines 71, 72, 73, and 74 (referred to as “the sixth configuration” hereinafter).

The sixth configuration can be considered a modification that multiplexing and demultiplexing are not performed on the antenna signals J4 and J5 in the third configuration.

The multiplexer 31 is disposed in the region 14R. The multiplexer 32 is disposed in the region 14L. The demultiplexers 21 and 22 are disposed in the region 12.

The function of the transmission lines 61 and 62, multiplexing on the antenna signals J1a, J1b, J2c, J2d, and J3 and demultiplexing on the multiplex signals J31 and J32 are the same as the multiplexing and demultiplexing performed in the first configuration.

Transmission of the antenna signal J2a in the transmission line 71 is already described in the second configuration. Transmission of the antenna signal J2b in the transmission line 72 is already described in the third configuration. Transmission of the antenna signal J5 in the transmission line 73 is already described in the second configuration. The transmission line 74 transmits the antenna signal J4 from the antenna 54 to the receiver 44. Transmission lines 61, 62, 71, 72, 73, and 74 are routed in the region 11.

The sixth configuration reduces the number of necessary transmission lines compared with the case where multiplexing and demultiplexing are not performed. However, an effect of the reduction is small compared with the first to fifth configurations.

Amplifier circuits such as low noise amplifiers 501a, 501b, 502c, 502d, and 503, for example, are preferably provided on an output side of each of the antennas 51a, 51b, 52c, and 52d disposed in the region 15 and the antenna 53 disposed in the region 14. The antennas 51a and 51b are used to receive radio broadcasting, the antennas 52a, 52b, 52c, and 52d are used to receive terrestrial digital broadcasting, the antenna 53 is used for reception in GPS, and a degree of intensity of the antenna signals J1a, J1b, J2c, J2d, and J53 which are to be multiplexed tends to be low. The reason is that loss occurs in the multiplexers 31 and 32 and the demultiplexers 21 and 22.

The antennas 52a and 52b disposed in the region 13 are not needed to be provided with a low noise amplifier. The reason is that the transmission lines 71 and 72 transmitting the antenna signals J2a and J2b between the antennas 52a and 52b and the receiver 42 can be short, and further, the antenna signals J2a and J2b are not multiplexed.

In the sixth configuration, the frequency in the range A, the frequency in the range B, or both the frequency in the range A and the frequency in the range B may be adopted to the mobile phone. The reason is that the antenna signal J4 corresponding to the mobile phone is not multiplexed.

### First Modification of Embodiment 3

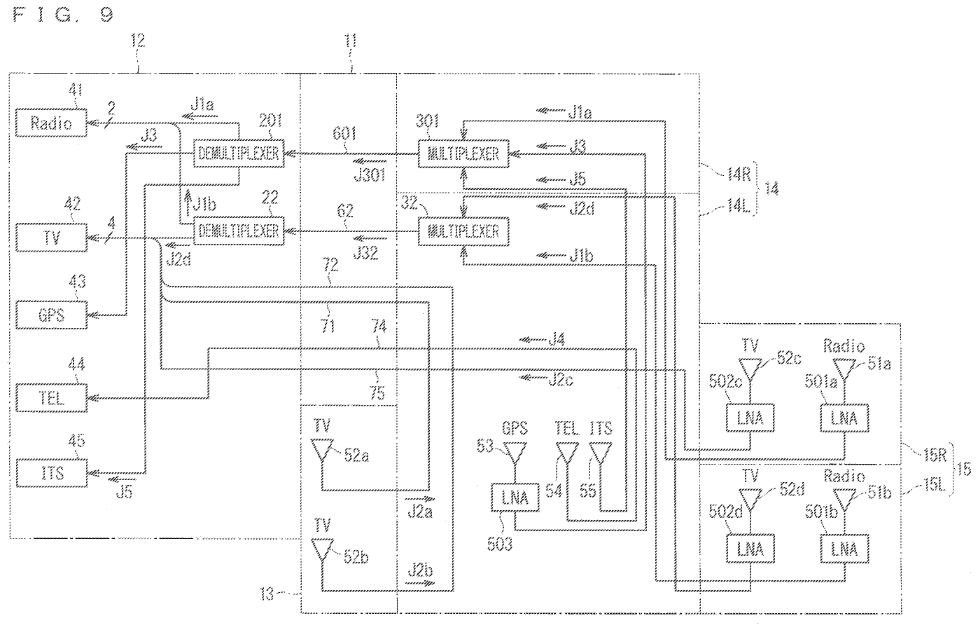

FIG. 9 is a block diagram illustrating a first modification of the in-vehicle wireless system according to the embodiment 3. In this modification, adopted to the sixth configuration is a configuration that the antenna signal J2c is not multiplexed and signal to be multiplexed with the antenna signals J1a and J3 is changed from the antenna signal J2c to the antenna signal J5.

More specifically, adopted to a configuration illustrated in FIG. 9 (referred to as “the seventh configuration” hereinafter) is a configuration that the multiplexer 31, the transmission lines 61 and 73, and the demultiplexer 21 in the sixth configuration are replaced with a multiplexer 301, transmission lines 601 and 75, and a demultiplexer 201.

The multiplexer 301 is disposed in the region 14R. The multiplexer 32 is disposed in the region 14L. The demultiplexers 201 and 22 are disposed in the region 12.

The antenna signals J1b and J2d and the multiplex signal J32 inputted and outputted between the multiplexer 32, the transmission line 62, and the demultiplexer 22 are already described in the first configuration.

The antenna signals J1a, J3, and J5 are inputted to the multiplexer 301, and the multiplexer 301 multiplexes the antenna signals J1a, J3, and J5 to obtain multiplex signal J301, and outputs the multiplex signal J301. The multiplex signal J301 is supplied from the multiplexer 301 to the transmission line 601.

The multiplex signal J301 is inputted to the demultiplexer 201. The demultiplexer 201 demultiplexes the multiplex signal J301 to obtain the antenna signal J1a, and outputs the antenna signal J1a to the receiver 41. The demultiplexer 201 demultiplexes the multiplex signal J301 to obtain the antenna signal J3, and outputs the antenna signal J3 to the receiver 43. The demultiplexer 201 demultiplexes the multiplex signal J301 to obtain the antenna signal J5, and outputs the antenna signal 35 to the receiver 45.

Transmission of the antenna signal J2a in the transmission line 71 is already described in the second configuration. Transmission of the antenna signal J2b in the transmission line 72 is already described in the third configuration. Transmission of the antenna signal J4 in the transmission line 74 is already described in the sixth configuration. The transmission line 75 transmits the antenna signal J2c from the antenna 52c to the receiver 42. Transmission lines 601, 62, 71, 72, 74, and 75 are routed in the region 11.

The receiver 41 receives the antenna signal J1a obtained from the demultiplexer 201 and the antenna signal J1b obtained from the demultiplexer 22 using a diversity form.

The receiver 42 receives the antenna signal J2d obtained from the demultiplexer 22, the antenna signal J2a obtained from the transmission line 71, the antenna signal J2b obtained from the transmission line 72, and the antenna signal J2c obtained from the transmission line 75 using a diversity form.

The receiver 43 receives the antenna signal J3 obtained from the demultiplexer 201. The receiver 44 receives the antenna signal J4 obtained from the transmission line 74. The receiver 45 receives the antenna signal J5 obtained from the demultiplexer 201.

The seventh configuration has an effect in common with the sixth configuration in that the number of transmission lines in the region 11 is reduced and the configuration contributes to at least one of the reduction in the number of transmission lines routed in the region 14 and the reduction in length thereof described above. The seventh configuration has an effect in common with the third configuration in that the number of multiplexers and demultiplexers is reduced.

In the seventh configuration, the frequency in the range A, the frequency in the range B, or both the frequency in the range A and the frequency in the range B may be adopted to the mobile phone. The reason is that the antenna signal J4 corresponding to the mobile phone is not multiplexed.

### Second Modification of Embodiment 3

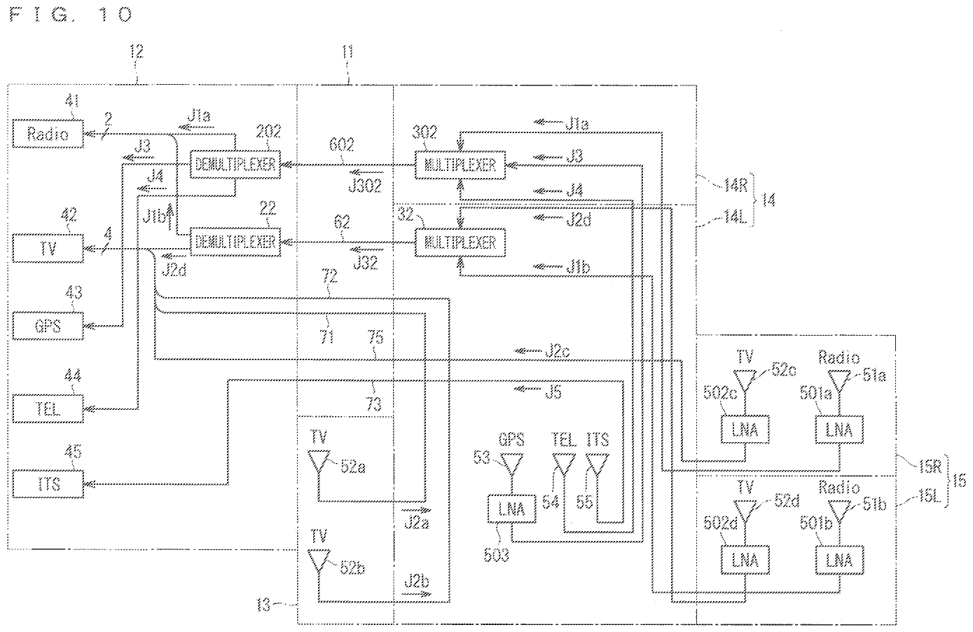

FIG. 10 is a block diagram illustrating a second modification of the in-vehicle wireless system according to the embodiment 3. In this modification, adopted to the sixth configuration is a configuration that the antenna signal J2c is not multiplexed and signal to be multiplexed with the antenna signals J1a and J3 is changed from the antenna signal J2c to the antenna signal J4.

More specifically, adopted to a configuration illustrated in FIG. 10 (referred to as “the eighth configuration” hereinafter) is a configuration that the multiplexer 31, the transmission lines 61 and 74, and the demultiplexer 21 in the sixth configuration are replaced with a multiplexer 302, transmission lines 602 and 75, and a demultiplexer 202.

The multiplexer 302 is disposed in the region 14R. The multiplexer 32 is disposed in the region 14L. The demultiplexers 202 and 22 are disposed in the region 12.

The antenna signals J1b and J2d and the multiplex signal J32 inputted and outputted between the multiplexer 32, the transmission line 62, and the demultiplexer 22 are already described in the first configuration.

The antenna signals J1a, J3, and J4 are inputted to the multiplexer 302, and the multiplexer 302 multiplexes the antenna signals J1a, J3, and 14 to obtain multiplex signal J302, and outputs the multiplex signal J302. The multiplex signal J302 is supplied from the multiplexer 302 to the transmission line 602.

The multiplex signal J302 is inputted to the demultiplexer 202. The demultiplexer 202 demultiplexes the multiplex signal J302 to obtain the antenna signal J1a, and outputs the antenna signal J1a to the receiver 41. The demultiplexer 202 demultiplexes the multiplex signal J302 to obtain the antenna signal J3, and outputs the antenna signal J3 to the receiver 43. The demultiplexer 202 demultiplexes the multiplex signal J302 to obtain the antenna signal J4, and outputs the antenna signal J4 to the receiver 44.

Transmission of the antenna signal J2a in the transmission line 71 is already described in the second configuration. Transmission of the antenna signal J2b in the transmission line 72 is already described in the third configuration. Transmission of the antenna signal J3 in the transmission line 73 is already described in the second configuration. Transmission of the antenna signal J2c in the transmission line 75 is already described in the seventh configuration. Transmission lines 602, 62, 71, 72, 73, and 75 are routed in the region 11.

The receiver 41 receives the antenna signal J1a obtained from the demultiplexer 202 and the antenna signal J1b obtained from the demultiplexer 22 using a diversity form.

The receiver 42 receives the antenna signal J2d obtained from the demultiplexer 22, the antenna signal J2a obtained from the transmission line 71, the antenna signal J2b obtained from the transmission line 72, and the antenna signal J2c obtained from the transmission line 75 using a diversity form.

The receiver 43 receives the antenna signal J3 obtained from the demultiplexer 202. The receiver 44 receives the antenna signal J4 obtained from the demultiplexer 202. The receiver 45 receives the antenna signal J5 obtained from the transmission line 73.

The eighth configuration has an effect in common with the sixth configuration in that the number of transmission lines in the region 11 is reduced and the configuration contributes to at least one of the reduction in the number of transmission lines routed in the region 14 and the reduction in length thereof described above. The eighth configuration has an effect in common with the third configuration in that the number of multiplexers and demultiplexers is reduced.

In the eighth configuration, the frequency in the range A is preferably adopted to the mobile phone. The reason is that a frequency adopted to the antenna signal J3 (the antenna signal J3 are adopted to GPS) multiplexed with the antenna signal J4 corresponding to the mobile phone in the multiplexer 302 is farther away from the range A in relation to the range B.

### Embodiment 4

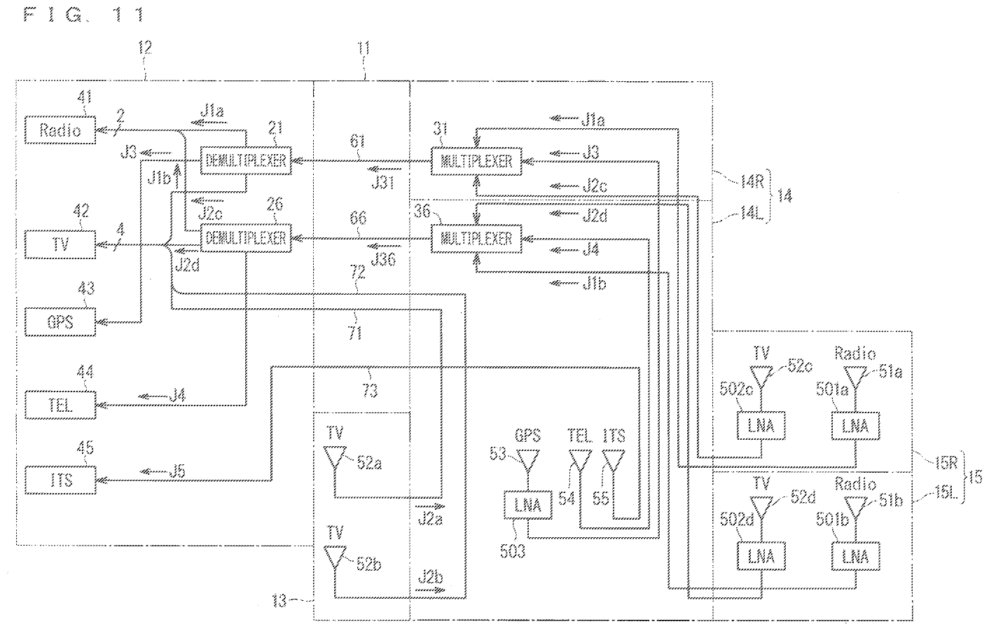

FIG. 11 is a block diagram illustrating an in-vehicle wireless system according to an embodiment 4. In the embodiment 4, adopted to the sixth configuration is a configuration that the antenna signal J4 is also multiplexed with the antenna signals J1b and J2d. More specifically, adopted is a configuration that the multiplexer 32, the transmission line 62, and the demultiplexer 22 in the sixth configuration are replaced with the multiplexer 36, the transmission line 66, and the demultiplexer 26, and the transmission line 74 is removed (referred to as “the ninth configuration” hereinafter).

The multiplexer 31 is disposed in the region 14R. The multiplexer 36 is disposed in the region 14L. The demultiplexers 21 and 26 are disposed in the region 12. Transmission lines 61, 66, 71, and 72 are routed in the region 11.

The antenna signals J1a, J2c, and J3 and the multiplex signal J31 inputted and outputted between the multiplexer 31, the transmission line 61, and the demultiplexer 21 are already described in the first configuration. The antenna signals J1b, J2d, and J4 and the multiplex signal J36 inputted and outputted between the multiplexer 36, the transmission line 66, and the demultiplexer 26 are already described in the third configuration. Transmission of the antenna signal J2a in the transmission line 71 is already described in the second configuration. Transmission of the antenna signal J2b in the transmission line 72 is already described in the third configuration. The low noise amplifiers 501a, 501b, 502c, 502d, and 503 are already described in the sixth configuration.

The ninth configuration has an effect in common with the sixth configuration to the eighth configuration in that the number of transmission lines in the region 11 is reduced and the configuration contributes to at least one of the reduction in the number of transmission lines routed in the region 14 and the reduction in length thereof described above. The ninth configuration has an advantage in that the number of transmission lines routed in the region 11 is reduced by one compared with the sixth configuration to the eighth configuration.

The ninth configuration has an effect in common with the third configuration in that the number of multiplexers and demultiplexers is reduced.

In the ninth configuration, any of the frequency in the range A and the frequency in the range B may be adopted to the mobile phone. The reason is that a frequency 100 MHz or more away from the frequency in the ranges A and B is adopted to both the antenna signals J1b and J2d multiplexed with the antenna signal J4 corresponding to the mobile phone in the multiplexer 36.

In the ninth configuration, both the frequency in the range A and the frequency in the range B may be adopted to the mobile phone. The multiplexer 36 in this case is assumed to multiplex the antenna signal J4 using a function of a high-pass filter.

### Generalized Description

The description of generalizing the first configuration to the ninth configuration is performed in association with the first configuration to the ninth configuration.

An in-vehicle wireless system according to the present disclosure includes a plurality of groups, a multiplexer, a demultiplexer, and a transmission line each mounted to a vehicle. The in-vehicle wireless system 8 includes the groups 100, 200, 300, 400, and 500 in any of the first configuration to the ninth configuration.

Two of the plurality of groups are selected and described as “the first group” and “the second group”. The first group includes a plurality of first antennas and a first receiver. The second group includes a plurality of second antennas and a second receiver. Each of the first antennas outputs a first signal according to a first communication form, and each of the second antennas outputs a second signal according to a second communication form. The second communication form is different from the first communication form. The first receiver receives the first signals individually outputted from the first antennas using a diversity form. The second receiver receives the second signals individually outputted from the second antennas using a diversity form.

When such an expression is applied to the first configuration to the ninth configuration, the group 100 corresponds to the first group and the group 200 corresponds to the second group. The antennas 51a and Sib correspond to the plurality of first antennas, and the receiver 41 corresponds to the first receiver. A communication form adopted to radio broadcasting corresponds to the first communication form, and the antenna signals J1a and J1b correspond to the first signals. The antenna signals J1a and J1b are individually outputted from the antennas 51a and Sib, respectively, and the receiver 41 receives the antenna signals J1a and J1b using a diversity form.

The antennas 52a, 52b, 52c, and 52d correspond to the plurality of second antennas, and the receiver 42 corresponds to the second receiver. A communication form adopted to terrestrial digital broadcasting corresponds to the second communication form, and the antenna signals J2a, J2b, J2c, and J2d correspond to the second signals. The antenna signals J2a, J2b, J2c, and J2d are individually outputted from the antennas 52a, 52b, 52c, and 52d, respectively, and the receiver 42 receives the antenna signals J2a, J2b, J2c, and J2d using a diversity form.

The multiplexer supplies the multiplex signal obtained by multiplexing at least the first signal obtained from the initial one of the first antennas and the second signal obtained from the initial one of the second antennas to the transmission line. The demultiplexer supplies the first signal and the second signal obtained by demultiplexing the multiplex signal to the first receiver and the second receiver, respectively.

“The initial one of the first antennas” indicates one of “the plurality of first antennas”. “The initial one of the second antennas” indicates one of “the plurality of second antennas”.

(X1) Description in Line with First Configuration.

The above expression is described in line with the first configuration. When it is considered that the group 100 corresponds to the first group and the group 200 corresponds to the second group, it can be considered that the antenna 51a corresponds to the initial one of the first antennas and the antenna 52c corresponds to the initial one of the second antennas, for example. The receivers 41 and 42 correspond to the first receiver and the second receiver, respectively,

When the correspondence is considered as described above, the antenna signals J1a and J2c correspond to the first signal and the second signal, respectively. The multiplexer 31 multiplexes the antenna signals J1a, J2c, and J3 to obtain the multiplex signal J31. Thus, the multiplexer 31 multiplexes at least the antenna signal J1a as the first signal and the antenna signal J2c as the second signal to supply the multiplex signal J31 to the transmission line 61.

The demultiplexer 21 supplies the antenna signal J1a as the first signal and the antenna signal J2c as the second signal, both of which are obtained by demultiplexing the multiplex signal J31, to the receiver 41 as the first receiver and the receiver 42 as the second receiver, respectively.

The antenna signals J1a and J2c are multiplexed by such a function of the multiplexer 31 and the demultiplexer 21, and the multiplex signal J31 is transmitted in one transmission line 61. This technique contributes to reduction in the number of the transmission lines.

The antenna signal J1a conforms to a communication form adopted to radio broadcasting, and the antenna signal J2c conform to a communication form adopted to terrestrial digital broadcasting. Thus, a frequency conversion circuit and a non-linear amplifier are not necessary.

When it is considered that the group 100 corresponds to the first group and the group 200 corresponds to the second group, it can also be considered that the antenna 51b corresponds to the initial one of the first antennas and the antenna 52d corresponds to the initial one of the second antennas. The receivers 41 and 42 correspond to the first receiver and the second receiver, respectively.

When the correspondence is considered as described above, the antenna signals J1b and J2d correspond to the first signal and the second signal, respectively, and the multiplex signal J32 corresponds to the multiplex signal. The multiplexer 32 multiplexes the antenna signals J1b, and J2d to obtain the multiplex signal J32. Thus, the multiplexer 32 multiplexes at least the antenna signals J1b as the first signal and the antenna signal J2d as the second signal to supply the multiplex signal J32 as the multiplex signal to the transmission line 62.

The demultiplexer 22 supplies the antenna signal J1b and the antenna signal J2d as the second signals obtained by demultiplexing the multiplex signal J32 as the multiplex signal to the receiver 41 as the first receiver and the receiver 42 as the second receiver, respectively.

The antenna signals J1b and J2d are multiplexed by such a function of the multiplexer 32 and the demultiplexer 22, and the multiplex signal J32 is transmitted in one transmission line 62. This technique contributes to reduction in the number of the transmission lines.

When the correspondence is considered as described above, the configuration of collectively locating the antennas 51a and 52c in the region 15R is preferable in a viewpoint of reducing the length of the transmission line connecting the multiplexer 31 and the antennas 51a and 52c. A distance between the antenna 51a and the antenna 52c is preferably shorter than a distance between the antenna 51a and the antenna 51b.

In the similar manner, the configuration of collectively locating the antennas 51b and 52d in the region 15L is preferable in a viewpoint of reducing the length of the transmission line connecting the multiplexer 32 and the antennas 51b and 52d. A distance between the antenna 51b and the antenna 52d is preferably shorter than a distance between the antenna 51b and the antenna 52c.

A case where it is considered that the group 200 corresponds to the first group and the group 100 corresponds to the second group is described in a manner similar to the case where it is considered that the group 100 corresponds to the first group and the group 200 corresponds to the second group. The multiplex signal J32 is transmitted in one transmission line 61 by the function of the multiplexer 31 and the demultiplexer 21, or the multiplex signal J32 is transmitted in one transmission line 62 by the function of the multiplexer 32 and the demultiplexer 22.

In addition to the correspondence described above, a case where the antenna signals J2c and J1b correspond to the first signal and the second signal as a signal multiplexed by the multiplexer 31, respectively, and the antenna signals J2d and J1a correspond to the first signal and the second signal as a signal multiplexed by the multiplexer 32 may also be assumed.

However, when such a correspondence is adopted, the multiplexer 31 located in the region 14R and the antenna 51b located in the region 15L are needed to be connected, and the multiplexer 32 located in the region 14L and the antenna 51a located in the region 15R are needed to be connected. This connection has a disadvantage in that the transmission line routed in the region 14 is long compared with the first configuration where the multiplexer 31 located in the region 14R and the antennas 51a and 52c, both of which are located in the region 15R, are connected, and the multiplexer 32 located in the region 14L and the antennas 51b and 52d, both of which are located in the region 15L, are connected.

As adopted in the first configuration, preferable is the configuration that both the distance between the multiplexer 31 and the antenna 51a and the distance between the multiplexer 31 and the antenna 52c are shorter than both the distance between the multiplexer 31 and the antenna 51b and the distance between the multiplexer 31 and the antenna 52d in a viewpoint that the length of the transmission line connecting the multiplexer and the antenna outputting the antenna signal multiplexed by the multiplexer is reduced.

In the similar manner, preferable is the configuration that both the distance between the multiplexer 32 and the antenna Sib and the distance between the multiplexer 32 and the antenna 52d are shorter than both the distance between the multiplexer 32 and the antenna 51a and the distance between the multiplexer 32 and the antenna 52c.

(X2) Description in Line with Second Configuration.

The description relating to the transmission lines 61 and 62 in the above description the first configuration described above is also applied to the second configuration. When it is considered that the group 200 corresponds to the first group in the second configuration, it can be considered that the antenna 52a and the antenna signal J2a correspond to the first antenna and the first signal, respectively. However, the antenna signal J2a is not multiplexed in the second configuration. In the present disclosure, all of the plurality of first signals are not needed to be multiplexed by the multiplexer. At least one of the first signals is multiplexed, thus the number of transmission lines is reduced.

When it is considered that the group 100 corresponds to the first group in the second configuration, it can be considered that the antenna 52a and the antenna signal J2a corresponds to the second antenna and the second signal, respectively. However, the antenna signal J2a is not multiplexed in the second configuration. In the present disclosure, all of the plurality of second signals are not needed to be multiplexed by the multiplexer. At least one of the second signals is multiplexed, thus the number of transmission lines is reduced.

(X3) Description in Line with Third Configuration.

The description focuses on the function of the multiplexer 35 in the third configuration. The multiplexer 35 multiplexes the antenna signals J1a, J2c, J3, and J5 to obtain multiplex signal J35, and supplies the multiplex signal J35 to the transmission line 65.

Thus, it can be considered that the group 100 corresponds to the first group and the group 200 corresponds to the second group. When such a correspondence is considered, the antenna 51a corresponds to the initial one of the first antennas and the antenna 52c corresponds to the initial one of the second antennas.

When the correspondence is considered as described above, the antenna signal J1a corresponds to the first signal, the antenna signal J2c corresponds to the second signal, and the multiplex signal J35 corresponds to the multiplex signal. The multiplexer 35 multiplexes at least the antenna signal J1a and the antenna signal J2c to obtain the multiplex signal J35.

The demultiplexer 25 supplies the antenna signal J1a as the first signal obtained by demultiplexing the multiplex signal J35 as the multiplex signal to the receiver 41 as the first receiver. The demultiplexer 25 supplies the antenna signal J2c as the second signal obtained by demultiplexing the multiplex signal J35 as the multiplex signal to the receiver 42 as the second receiver.

It can be considered that the group 200 corresponds to the first group and the group 100 corresponds to the second group. When such a correspondence is considered, the antenna 52c corresponds to the initial one of the first antennas and the antenna 51a corresponds to the initial one of the second antennas.

When the correspondence is considered as described above, the antenna signal J2c corresponds to the first signal, the antenna signal J a corresponds to the second signal, and the multiplex signal J35 corresponds to the multiplex signal. The multiplexer 35 multiplexes at least the antenna signal J2c and the antenna signal Jia to obtain the multiplex signal J35.

The demultiplexer 25 supplies the antenna signal J2c as the first signal obtained by demultiplexing the multiplex signal J35 as the multiplex signal to the receiver 42 as the first receiver. The demultiplexer 25 supplies the antenna signal J1a as the second signal obtained by demultiplexing the multiplex signal J35 as the multiplex signal to the receiver 41 as the second receiver.

The transmission of the multiplex signal J35 in one transmission line 65 contributes to reduction in the number of the transmission lines.

The description focuses on the function of the multiplexer 36 in the third configuration. The multiplexer 36 multiplexes the antenna signals J1b, J2d, and J4 to obtain multiplex signal J36, and supplies the multiplex signal J36 to the transmission line 66.

Thus, it can be considered that the group 100 corresponds to the first group and the group 200 corresponds to the second group. When such a correspondence is considered, the antenna 51b corresponds to the initial one of the first antennas and the antenna 52d corresponds to the initial one of the second antennas.

When the correspondence is considered as described above, the antenna signal J1b corresponds to the first signal, the antenna signal J2d corresponds to the second signal, and the multiplex signal J36 corresponds to the multiplex signal. The multiplexer 36 multiplexes at least the antenna signal J1b and the antenna signal J2d to obtain the multiplex signal J36.

The demultiplexer 26 supplies the antenna signal J1b as the first signal obtained by demultiplexing the multiplex signal J36 as the multiplex signal to the receiver 41 as the first receiver. The demultiplexer 26 supplies the antenna signal J2d as the second signal obtained by demultiplexing the multiplex signal J36 as the multiplex signal to the receiver 42 as the second receiver.

It can be considered that the group 200 corresponds to the first group and the group 100 corresponds to the second group. When such a correspondence is considered, the antenna 52d corresponds to the initial one of the first antennas and the antenna Sib corresponds to the initial one of the second antennas.

When the correspondence is considered as described above, the antenna signal J2d corresponds to the first signal, the antenna signal J1b corresponds to the second signal, and the multiplex signal J36 corresponds to the multiplex signal. The multiplexer 36 multiplexes at least the antenna signal J2d and the antenna signal J1b to obtain the multiplex signal J36.

The demultiplexer 26 supplies the antenna signal J2d as the first signal obtained by demultiplexing the multiplex signal J36 as the multiplex signal to the receiver 42 as the first receiver. The demultiplexer 26 supplies the antenna signal J1b as the second signal obtained by demultiplexing the multiplex signal J36 as the multiplex signal to the receiver 41 as the second receiver.

The transmission of the multiplex signal J36 in one transmission line 66 contributes to reduction in the number of the transmission lines.

(X4) Description in Line with Fourth Configuration.

The fourth configuration can be considered to be similar to the third configuration except that the antenna signals J4 and 35 are replaced. Thus, when the multiplexer 35 is read as the multiplexer 37, the multiplexer 36 is read as the multiplexer 38, the multiplex signal J35 is read as the multiplex signals J37, the multiplex signal J36 is read as the multiplex signal J38, the transmission line 65 is read as the transmission line 67, the transmission line 66 is read as the transmission line 68, the demultiplexer 25 is read as the demultiplexer 27, the demultiplexer 26 is read as the demultiplexer 28 in the description in line with the third configuration, the description in line with the fourth configuration is obtained.

The transmission of the multiplex signal J37 in one transmission line 67 in the fourth configuration contributes to reduction in the number of the transmission lines. The transmission of the multiplex signal J38 in one transmission line 68 contributes to reduction in the number of the transmission lines.

(X5) Description in Line with Fifth Configuration.

The description relating to the transmission line 61 in the first configuration is also applied to the fifth configuration, and the transmission of the multiplex signal J31 in one transmission line 61 contributes to reduction in the number of the transmission lines.

The description focuses on the function of the multiplexer 39. The multiplexer 39 multiplexes the antenna signals J1b, J2d, J4, and J5 to obtain multiplex signal J39, and supplies the multiplex signal J39 to the transmission line 69.

Thus, it can be considered that the group 100 corresponds to the first group and the group 200 corresponds to the second group. When such a correspondence is considered, the antenna 51b corresponds to the initial one of the first antennas and the antenna 52d corresponds to the initial one of the second antennas.

When the correspondence is considered as described above, the antenna signal J1b corresponds to the first signal, the antenna signal J2d corresponds to the second signal, and the multiplex signal J39 corresponds to the multiplex signal. The multiplexer 39 multiplexes at least the antenna signal J1b and the antenna signal J2d to obtain the multiplex signal J39.

The demultiplexer 29 supplies the antenna signal J1b as the first signal obtained by demultiplexing the multiplex signal J39 as the multiplex signal to the receiver 41 as the first receiver. The demultiplexer 29 supplies the antenna signal J2d as the second signal obtained by demultiplexing the multiplex signal J39 as the multiplex signal to the receiver 42 as the second receiver.

It can be considered that the group 200 corresponds to the first group and the group 100 corresponds to the second group. When such a correspondence is considered, the antenna 52d corresponds to the initial one of the first antennas and the antenna 51b corresponds to the initial one of the second antennas.

When the correspondence is considered as described above, the antenna signal J2d corresponds to the first signal, the antenna signal J1b corresponds to the second signal, and the multiplex signal J39 corresponds to the multiplex signal. The multiplexer 39 multiplexes at least the antenna signal J2d and the antenna signal J1b to obtain the multiplex signal J39.

The demultiplexer 29 supplies the antenna signal J2d as the first signal obtained by demultiplexing the multiplex signal J39 as the multiplex signal to the receiver 42 as the first receiver. The demultiplexer 29 supplies the antenna signal J1b as the second signal obtained by demultiplexing the multiplex signal J39 as the multiplex signal to the receiver 41 as the second receiver.

The transmission of the multiplex signal J39 in one transmission line 69 contributes to reduction in the number of the transmission lines.

(X6) Description in Line with Sixth Configuration.

The description relating to the transmission lines 61 and 62 in the above description on the first configuration is also applied to the sixth configuration. The transmission of the multiplex signal J31 in one transmission line 61 contributes to reduction in the number of the transmission lines, and the transmission of the multiplex signal J32 in one transmission line 62 contributes to reduction in the number of the transmission lines.

(X7) Description in Line with Seventh Configuration.

The description relating to the transmission line 62 in the above description on the first configuration is also applied to the seventh configuration, and the transmission of the multiplex signal J32 in one transmission line 62 contributes to reduction in the number of the transmission lines.

The description focuses on the function of the multiplexer 301 in the seventh configuration. The multiplexer 301 multiplexes the antenna signals J1a, J3, and J5 to obtain multiplex signal J301, and supplies the multiplex signal J301 to the transmission line 601.

It can be considered that the group 100 corresponds to the first group and the group 200 corresponds to the second group. When such a correspondence is considered, the antenna 51a corresponds to the initial one of the first antennas and the antenna 51b corresponds to the secondary one of the first antennas.

When the correspondence is considered as described above, the antenna signal J1a corresponds to an initial one of the first signals, the antenna signal J1b corresponds to a secondary one of the first signals. The multiplexer 301 multiplexes the antenna signal J1a and the antenna signals J3 and J5 to obtain the multiplex signal J301.

The demultiplexer 201 supplies the antenna signal J1a as the first signal obtained by demultiplexing the multiplex signal J301 as the multiplex signal to the receiver 41 as the first receiver. The demultiplexer 201 supplies the antenna signals J3 and J5 as the second signals obtained by demultiplexing the multiplex signal J301 as the multiplex signal to the receivers 43, 45 as the second receivers, respectively.

The transmission of the multiplex signal J301 in one transmission line 601 contributes to reduction in the number of the transmission lines. In this manner, one of the first signals may be multiplexed with the third signals (herein, at least one of the antenna signals J3 and J5) without a premise that a diversity form is adopted. The number of transmission lines is reduced even when all of the first signal are not multiplexed with the second signal.

(X8) Description in Line with Eighth Configuration.

The eighth configuration can be considered to be similar to the seventh configuration except that the antenna signals 14 and J5 are replaced. Thus, when the antennas 54 and 55 are replaced with each other, the antenna signals J4 and J5 are replaced with each other, the receivers 44 and 45 are replaced with each other, the multiplexer 301 is read as the multiplexer 302, the multiplex signal J301 is read as the multiplex signal J302, the transmission line 601 is read as the transmission line 602, and the demultiplexer 201 is read as the demultiplexer 202 in the description in line with the seventh configuration, the description in line with the eighth configuration is obtained.

The transmission of the multiplex signal J32 in one transmission line 62 in the eighth configuration contributes to reduction in the number of the transmission lines. The transmission of the multiplex signal J302 in one transmission line 602 contributes to reduction in the number of the transmission lines.

(X9) Description in Line with Ninth Configuration.

The description relating to the transmission line 61 in the above description on the first configuration is also applied to the ninth configuration, and the transmission of the multiplex signal J31 in one transmission line 61 contributes to reduction in the number of the transmission lines.

The description relating to the transmission line 66 in the above description on the third configuration is also applied to the ninth configuration, and the transmission of the multiplex signal J36 in one transmission line 66 contributes to reduction in the number of the transmission lines.

### Case where all of First Signals are Multiplexed with Second Signals

P and Q, each of which is an integer equal to or larger than 2, R which is an integer equal to or smaller than one of P and Q, which is smaller than the other one, and S which is any integer equal to or larger than 1 and equal to or smaller than R are introduced to suppose expressions described hereinafter:

(i) the number of the first antennas provided in the first group is P, and the number of the second antennas provided in the second group is Q:

(ii) the first receiver in the first group receives the first signal individually outputted from the first antennas of the first group using a diversity form, the second receiver in the second group receives the second signal individually outputted from the second antennas of the second group using a diversity form;

(iii) the R multiplexers and the R demultiplexers are provided;

(a) the Sth multiplexer multiplexes at least the first signal obtained from the Sth one of the first antennas and the second signal obtained from the Sth one of the second antennas to obtain the Sth one of the multiplex signals; and

(b) the Sth demultiplexer supplies the first signal and the second signal obtained by demultiplexing the Sth one of the multiplex signals to the first receiver and the second receiver, respectively.

In such a configuration, all of the first signals or all of the second signals are subject to multiplexing, thus an effect of reducing the transmission line is highly achieved.

The above expression is described in line with the first configuration. When it is considered that the group 100 corresponds to the first group and the group 200 corresponds to the second group, it is considered that the antennas 51a and 51b correspond to the first antennas and the antennas 52a, 52b, 52c, and 52d correspond to the second antennas, respectively. P=2 and Q=4 are satisfied in this correspondence, thus R=2 is satisfied.

When S=1 is satisfied, the multiplexer 31 multiplexes the antenna signal J1a as the first signal obtained from 51a as the first antenna and the antenna signal J2c as the second signal obtained from the antenna 52c as the second antenna to obtain the multiples signal J31. The demultiplexer 21 supplies the antenna signals J1a and J2c obtained by demultiplexing the multiplex signal J31 to the receivers 41 and 42, respectively.

When S=2 is satisfied, the multiplexer 32 multiplexes the antenna signal J1b as the first signal obtained from 51b as the first antenna and the antenna signal J2d as the second signal obtained from the antenna 52d as the second antenna to obtain the multiplex signal J32 as the multiplex signal. The demultiplexer 22 supplies the antenna signals J1b and J2d obtained by demultiplexing the multiplex signal J32 to the receivers 41 and 42, respectively.

The second configuration and the sixth configuration can be described in the same manner as the first configuration. In the third configuration, the multiplexers 31 and 32 are read as the multiplexers 35 and 36, respectively, the demultiplexers 21 and 22 are read as the demultiplexers 25 and 26, respectively, and multiplex signals J31 and J32 are read as the multiplex signals J35 and J36, respectively in the description described above for the first configuration, thus the third configuration is described in the manner similar to the first configuration.

In the fourth configuration, the multiplexers 31 and 32 are read as the multiplexers 37 and 38, respectively, the demultiplexers 21 and 22 are read as the demultiplexers 27 and 28, respectively, and multiplex signals J31 and J32 are read as the multiplex signals J37 and J38, respectively in the description described above for the first configuration, thus the fourth configuration is described in the manner similar to the first configuration.

In the fifth configuration, the multiplexer 32 is read as the multiplexer 39, the demultiplexer 22 is read as the demultiplexer 29, and multiplex signal J31 is read as the multiplex signal J39 in the description described above for the first configuration, thus the fifth configuration is described in the manner similar to the first configuration.

In the ninth configuration, the multiplexer 32 is read as the multiplexer 36, the demultiplexer 22 is read as the demultiplexer 26, and multiplex signal J32 is read as the multiplex signal J36 in the description described above for the first configuration, thus the ninth configuration is described in the manner similar to the first configuration.

When it is considered that the group 200 corresponds to the first group and the group 100 corresponds to the second group, it is considered that the antennas 52a, 52b, 52c, and 52d correspond to the first antennas and the antennas 51a and 51b correspond to the second antennas. P=4 and Q=2 are satisfied in this correspondence, thus R=2 is satisfied.

Described also in this case is the expression described above for the first to sixth configurations and the ninth configuration in the manner similar to a case of P=2 and Q=4.

When it is considered that the group 100 corresponds to the first group and the group 200 corresponds to the second group, the integer Q described above is larger than the integer P (Q=4 and P=2). It is preferable that, in a viewpoint that the length of the transmission line connecting the multiplexer and the antenna outputting the antenna signal to be multiplexed by the multiplexer is reduced, an Lth one of the second antennas is closer to the second receiver in relation to all of the multiplexers in any case of an integer L equal to or smaller than Q and equal to or larger than (P+1).

The integer L is equal to or smaller than 4 and equal to or larger 3 in the first to ninth configurations. A tertiary one of the second antennas is one of the antennas 52a and 52b, and a quaternary one of the second antennas is the other one of the antennas 52a and 52b.

Both the antennas 52a and 52b are closer to the receivers 41 and 42 as the second receivers in relation to the multiplexers 31, 32, 33, and 34 (the first configuration), the multiplexers 31, 32, and 33 (the second configuration), the multiplexers 35 and 36 (the third configuration), the multiplexers 37 and 38 (the fourth configuration), the multiplexers 31 and 39 (the fifth configuration), the multiplexers 31 and 32 (the sixth configuration), the multiplexers 301 and 32 (the seventh configuration), the multiplexers 302 and 32 (the eighth configuration), and the multiplexers 31 and 36 (the ninth configuration).

Any of the antenna signals J2a and J2b respectively outputted by the antennas 52a and 52b and any of the antenna signals J1a and J1b are not multiplexed. Such an arrangement of the antennas 52a and 52b has an advantage in a viewpoint of reducing the transmission line routed in the region 14.

### Multiplexing of Second Signal and Third Signal

Described hereinafter is a technical feature in common with the first configuration (refer to FIG. 3), the second configuration (refer to FIG. 4), the third configuration (refer to FIG. 5), the fifth configuration (refer to FIG. 7), and the ninth configuration (refer to FIG. 11).

The groups 300, 400, and 500 are collectively considered a third group 600. The third group 600 includes antennas 53, 54, 55 as third antennas and receivers 43, 44, and 45 corresponding to the antennas 53, 54, and 55, respectively.

The antennas 53, 54, and 55 individually output the antenna signals 13, 14, and J5, respectively. The antenna signal J3 is a GPS signal according to a communication form adopted to GPS. The antenna signal J4 is a TEL signal according to a communication form adopted to a mobile phone. The antenna signal J5 is an ITS signal according to a communication form adopted to ITS.

These communication forms are not treated as a communication form adopted to radio broadcasting as the first communication form or a communication form adopted to terrestrial digital broadcasting as the second communication form, but is treated as a third communication form. There are three types of the third communication forms different from each other in the present disclosure. The antennas 53, 54, and 55 are treated as the third antennas and the antenna signals J3 J4, and J5 are treated as the third signals in accordance with such a treatment.

The receivers 43, 44, and 45 receive the antenna signals J3, J4, and J5 as the third signal individually outputted from the antennas 53, 54, and 55 as the third antennas corresponding to the receivers 43, 44, and 45, respectively.

With reference to Table 1, a frequency range adopted to the antenna signal J4 is 815 MHz to 960 MHz (the range A) or 1710 MHz to 1990 Hz (the range B), and a frequency range adopted to the antenna signal J5 is 755 to 765 MHz.

With reference to Table 1, a frequency range adopted to the antenna signals J2a, J2b, J2c, and J2d is 470 to 710 MHz, and a frequency range adopted to the antenna signals J1a and J1b is equal to or smaller than 120 MHz.

Accordingly, when the antenna signal 34 is treated as the initial one of the third signals and the antenna signal J5 are treated as the secondary one of the third signals, a frequency range adopted to the secondary one of the third signals ranges between a frequency range adopted to the second signal and a frequency range adopted to the initial one of the third signals regardless of which one of the groups 100 and 200 the second group corresponds to.

The antenna signal J4 is not multiplexed with the antenna signal J5 but is multiplexed with one of the second signals in the first configuration, the second configuration, the third configuration, the fifth configuration, and the ninth configuration. The multiplex signal obtained by this multiplexing is multiplexed to obtain the antenna signal J4, and the antenna signal J4 is supplied to the receiver 44.

More specifically, the antenna signal J4 is multiplexed with the antenna signal J2b to obtain the multiplex signal J33 in the first configuration and the second configuration. The antenna signal J4 is multiplexed with the antenna signals J2d and J1b to obtain the multiplex signal J36 in the third configuration and the ninth configuration. The antenna signal J4 is multiplexed with the antenna signals J2d and J1b to obtain the multiplex signal J39 in the fifth configuration.

It is preferable that the initial one of the third signals is not multiplexed with the secondary one of the third signals but is multiplexed with one of the second signals in a viewpoint of increasing a difference between the frequency ranges adopted to the signal to be multiplexed. In the manner as described above, the reason is that a degree of technical difficulty in constituting the multiplexer is lower in a case where the frequency ranges of the signal to be multiplexed by the multiplexer are away from each other than a case where they are close to each other, and the same applies to a case of the demultiplexer.

### Additional Statement

The receivers 44 and 45 may be wireless devices having not only a reception function but also a transmission function as a modification of the fifth configuration.

The receivers 44 and 45 having the transmission function are treated as the wireless devices 44 and 45, respectively. The fifth configuration is a second modification of the in-vehicle wireless system according to the embodiment 2, thus this modification can be considered a further modification of the second modification of the in-vehicle wireless system according to the embodiment 2.

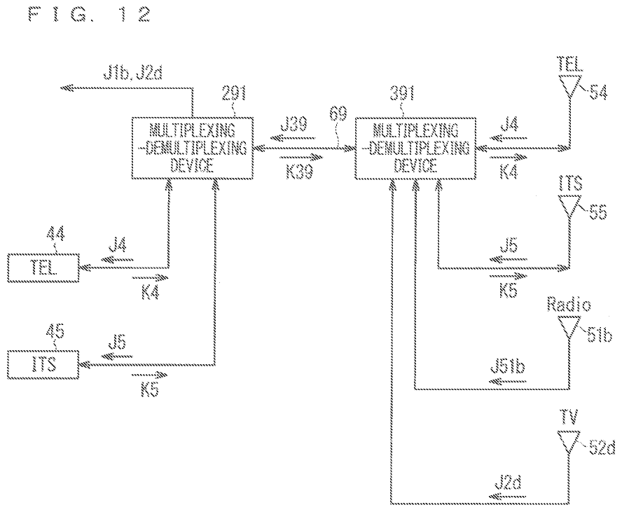

FIG. 12 is a block diagram illustrating this modification. Only a portion and a surrounding portion changed from the configuration in FIG. 7 illustrating the fifth configuration are illustrated.

In this modification, the wireless device 44 performs not only the reception of the antenna signal J4 but also the transmission of signal K4, and the wireless device 45 performs not only the reception of the antenna signal J5 but also the transmission of signal K5.

In this modification, the demultiplexer 29 is replaced with a multiplexing-demultiplexing device 291, and the multiplexer 39 is replaced with a multiplexing-demultiplexing device 391.

The multiplexing-demultiplexing device 291 has a function of demultiplexing the multiplex signal J39 to obtain the antenna signals J4 and J5 in the manner similar to the demultiplexer 29, and also has a function of multiplexing the signals K4 and K5 to obtain the multiplex signal K39. The multiplexing-demultiplexing device 391 has a function of multiplexing the antenna signals J4 and J5 to obtain the multiplex signal J39 in the manner similar to the multiplexer 39, and also has a function of demultiplexing the multiplex signal K39 to obtain the signals K4 and K5.

The multiplex signal K39 is transmitted by the transmission line 63. The signal K4 is supplied to the antenna 54 and released as radio waves. The signal K5 is supplied to the antenna 55 and released as radio waves.

The above configurations are generally expressed. The receivers 44 and 45 are treated as the first wireless device and the second wireless device, respectively. The signal K4 is treated as a fourth signal according to a communication form adopted to a mobile phone as the initial one of the third communication forms. The signal K5 is treated as a fifth signal according to a communication form adopted to ITS as the secondary one of the third communication forms.

In this modification, the multiplexing-demultiplexing device 291 also functions as a transmission multiplexer multiplexing the signal K4 as the fourth signal and the signal K5 as the fifth signal to obtain the multiplex signal K39 as the sixth signal.

In this modification, the multiplexing-demultiplexing device 391 also functions as an output multiplexer supplying the signal K4 obtained by demultiplexing the multiplex signal K39 as the sixth signal to the antenna 54 as the third antenna corresponding to the wireless device 44 as the first wireless device, and supplying the signal K5 obtained by demultiplexing the multiplex signal K39 as the sixth signal to the antenna 55 as the third antenna corresponding to the wireless device 45 as the second wireless device. In the above configuration, the number of transmission lines is reduced also for the transmission.

The multiplexers may be appropriately collected and modularized in any of the first configuration to the ninth configuration described above. Specifically, it is also applicable that the multiplexer 32 is not disposed in the region 14L but is disposed in the region 14R, and is modularized with the multiplexer 31 in the first configuration, the second configuration, and the sixth configuration, for example. It is also applicable that the multiplexer 35 is not disposed in the region 14L but is disposed in the region 14R, and is modularized with the multiplexer 36 in the region 14R in the third configuration. It is also applicable that the multiplexer 37 is not disposed in the region 14L but is disposed in the region 14R, and is modularized with the multiplexer 38 in the region 14R in the fourth configuration. It is also applicable that the multiplexer 31 is not disposed in the region 14L but is disposed in the region 14R, and is modularized with the multiplexer 39 in the region 14R in the fifth configuration. It is also applicable that the multiplexer 32 is not disposed in the region 14L but is disposed in the region 14R, and is modularized with the multiplexer 301 in the region 14R in the seventh configuration. It is also applicable that the multiplexer 32 is not disposed in the region 14L but is disposed in the region 14R, and is modularized with the multiplexer 302 in the region 14R in the eighth configuration. It is also applicable that the multiplexer 36 is not disposed in the region 141L but is disposed in the region 14R, and is modularized with the multiplexer 31 in the region 14R in the ninth configuration.

The antennas 53, 54, and 55 may be disposed near a center of the region 14 in any of the first configuration to the ninth configuration. Specifically, the antennas 53, 54, and 55 may be disposed, in the region 14L, close to the region 14R. For example, the antennas 53, 54, and 55 may be mounted in a form commonly referred to as a shark fin antenna.

Each configuration described in each embodiment and each modification example described above can be appropriately combined as long as they are not contradictory.

### EXPLANATION OF REFERENCE SIGNS

1 vehicle body
8 in-vehicle wireless system
11, 12, 13, 14, 14R, 141, 15, 15R, 15L region
21, 22, 23, 24, 25, 26, 27, 28, 29, 201, 202 demultiplexer
31, 32, 33, 34, 35, 36, 37, 38, 39, 301, 302 multiplexer
291, 391 multiplexing-demultiplexing device
41, 42, 43 receiver
44, 45 receiver (wireless device)
51a, 51b, 52a, 52b, 52c, 52d, 53, 54, 55 antenna
61, 62, 63, 64, 65, 67, 68, 69, 71, 72, 73, 74, 75 transmission line
100, 200, 300, 400, 500 group
501a, 501b, 502c, 502d low noise amplifier
600 third group
A, B range
J1a, J1b, J2a, J2b, J2c, J2d, J3, J4, J5 antenna signal
J31, J32, J33, J34, J35, J36, J37, J38, J39, J301, J302, K39 multiplex signal
K4, K5 signal

1. An in-vehicle wireless system, comprising
a first group, a second group, a multiplexer, a demultiplexer, and a transmission line each mounted to a vehicle, wherein
the first group includes first antennas and a first receiver,
the second group includes second antennas and a second receiver,
each of the first antennas outputs a first signal according to a first communication form,
each of the second antennas outputs a second signal according to a second communication form different from the first communication form,
the first receiver receives the first signals individually outputted from the first antennas using a diversity form,
the second receiver receives the second signals individually outputted from the second antennas using a diversity form,
the multiplexer supplies a multiplex signal, which is a signal obtained by multiplexing at least the first signal obtained from an initial one of the first antennas and the second signal obtained from an initial one of the second antennas, to the transmission line, and
the demultiplexer supplies the first signal and the second signal obtained by demultiplexing the multiplex signal to the first receiver and the second receiver, respectively.

2. The in-vehicle wireless system according to claim 1, wherein
a distance between the initial one of the first antennas and the initial one of the second antennas is shorter than a distance between the initial one of the first antennas and a secondary one of the first antennas.

3. The in-vehicle wireless system according to claim 1, wherein
the first antennas, a total number of which is P, are provided in the first group,
the second antennas, a total number of which is Q, are provided in the second group,
multiplexers, a total number of which is R, are provided,
demultiplexers, a total number of which is R, are provided,
in any case where each of P and Q is an integer equal to or larger than 2, R is an integer equal to one of P and Q, which is smaller than another one of P and Q, and S is an integer equal to or smaller than R and equal to or larger than 1,
(a) an Sth one of the multiplexers multiplexes at least the first signal obtained from an Sth one of the first antennas and the second signal obtained from an Sth one of the second antennas to obtain an Sth one of the multiplex signals; and
(b) an Sth one of the demultiplexers supplies the first signal and the second signal, both of which are obtained by demultiplexing the Sth one of the multiplex signals, to the first receiver and the second receiver, respectively.

4. The in-vehicle wireless system according to claim 3, wherein
both a distance between an initial one of the multiplexers and the initial one of the first antennas and a distance between the initial one of the multiplexers and the initial one of the second antennas are shorter than a distance between the initial one of the multiplexers and a secondary one of the first antennas and a distance between the initial one of the multiplexers and a secondary one of the second antennas, and
both a distance between a secondary one of the multiplexers and the secondary one of the first antennas and a distance between the secondary one of the multiplexers and the secondary one of the second antennas are shorter than a distance between the secondary one of the multiplexers and the initial one of the first antennas and a distance between the secondary one of the multiplexers and the initial one of the second antennas.

5. The in-vehicle wireless system according to claim 3, wherein
an integer Q is larger than an integer P,
an Lth one of the second antennas is located closer to the second receiver in relation to all of the multiplexers, and
L is equal to or smaller than Q, and any integer equal to or larger than (P+1) is applied to the L.

6. The in-vehicle wireless system according to claim 3, further comprising
a third group mounted to a vehicle, wherein
the third group includes third antennas and wireless devices corresponding to each of the third antennas,
all of the third antennas output third signals according to third communication systems, which are different from the first communication system and the second communication system and are different from each other,
the wireless devices receive the third signals individually outputted from the third antennas corresponding to the wireless devices,
an initial one of the third signals is not multiplexed with a secondary one of the third signals but is multiplexed with any of the second signals to obtain a second multiplex signal,
the initial one of the third signals obtained by demultiplexing the second multiplex signal is supplied to an initial one of the wireless devices corresponding to the initial one of the third signals, and
a frequency range adopted to the secondary one of the third signals ranges between a frequency range adopted to the second signals and a frequency range adopted to the initial one of the third signals.

7. The in-vehicle wireless system according to claim 6, wherein
an initial one of the wireless devices has a function of outputting a fourth signal according to an initial one of the third communication forms, and
a secondary one of the wireless devices has a function of outputting a fifth signal according to a secondary one of the third communication forms,
the in-vehicle wireless system further comprising:
a transmission multiplexer multiplexing the fourth signal and the fifth signal to obtain a sixth signal; and
an output demultiplexer supplying the fourth signal obtained by demultiplexing the sixth signal to the third antennas corresponding to the initial one of the wireless devices and supplying the fifth signal obtained by demultiplexing the sixth signal to the third antennas corresponding to the secondary one of the wireless devices.
